(19) United States
(12) Patent Application Publication
(10) Pub. No.: US 2011/0168468 A1
(43) Pub. Date: Jul. 14, 2011

(54) STRUCTURE OF ELECTRIC VEHICLE

(75) Inventors: Tomoo Taguchi, Higashihiroshima-shi (JP); Kouji Iwasaka, Hiroshima-shi (JP); Hiromichi Kawamura, Hiroshima-shi (JP)

(73) Assignee: MAZDA MOTOR CORPORATION, Aki-gun (JP)

(21) Appl. No.: 13/007,490

(22) Filed: Jan. 14, 2011

(30) Foreign Application Priority Data
Jan. 14, 2010 (JP) 2010-006267
Jan. 14, 2010 (JP) 2010-006269

(51) Int. Cl. B60K 6/46

(52) U.S. Cl. 180/65.245; 180/65.22; 903/903

(57) ABSTRACT

This disclosure provides a structure of an electric vehicle, which includes an engine, an electric generator which is driven by the engine, a battery which is supplied and charged with generated power at least from the electric generator, and a motor which is supplied with power from the battery to drive driving wheels. The engine and the electric generator are arranged inside a floor tunnel that is formed in a center part of a floor panel along the vehicle width axis so as to extend along the vehicle front-to-rear axis and bulge upward.

### BACKGROUND

The present invention relates to a structure of an electric vehicle including an engine, an electric generator which is driven by the engine, a battery which is supplied and charged with generated power at least from the electric generator, and a motor which is supplied with the power from the battery to drive driving wheels.

Conventionally, a structure of an electric vehicle including an engine, an electric generator which is driven by the engine, a battery which is supplied and charged with generated power at least from the electric generator, and a motor which is supplied with the power from the battery to drive driving wheels is known.

In a vehicle structure disclosed in JP2006-51943A, inside an engine room, an electric motor is arranged near an engine, a battery as a power supply source of the electric motor is arranged under rear seat(s), and a fuel tank is arranged below a floor under a driver's seat and a front passenger seat.

In the meantime, as such an electric vehicle, a plug-in hybrid vehicle is known, in which, when traveling a short distance, power in the battery charged by being supplied with the external power is supplied to the motor to drive driving wheels. On the other hand, when traveling a long distance, an electric generator is driven by the engine, the generated power is supplied to the battery for charging, and the charged power in the battery is supplied to the motor to drive the driving wheels. In this plug-in hybrid vehicle, as described above, since the engine is driven basically only when traveling the long distance, the engine can be downsized.

Here, in the electric vehicle, especially in the plug-in hybrid vehicle equipped with the downsized engine, it is desired that, by devising the arrangement of the engine and the electric generator, the center of gravity of the vehicle is lowered and a yaw moment of inertia is decreased. At the same time, it is desired that a degree of freedom in designing a space of a vehicle front part (e.g., a vehicle front space in front of a dashboard panel partitioned from a vehicle cabin by the dashboard panel) is improved, for example, by using the vehicle front space as a cargo space.

### SUMMARY

The present invention is made in view of the above situations to provide a structure of an electric vehicle including an engine, an electric generator which is driven by the engine, a battery for at least being supplied and charged with generated power from the electric generator, and a motor which is supplied with power from the battery to drive driving wheels to lower the center of gravity, decrease a yaw moment of inertia, and improve a degree of freedom in designing a vehicle front space.

According to one aspect of the present invention, a structure of an electric vehicle includes an engine, an electric generator which is driven by the engine, a battery which is supplied and charged with generated power at least from the electric generator, and a motor which is supplied with power from the battery to drive driving wheels. The engine and the electric generator are arranged inside a floor tunnel that is formed in a center part of a floor panel along the vehicle width axis so as to extend along the vehicle front-to-rear axis and be bulged upward.

As described above, the engine and the electric generator are arranged inside the floor tunnel, and the engine and the electric generator which are comparatively heavy are arranged in the center part of the vehicle along the vehicle front-to-rear axis. Therefore, the center of gravity can be lowered and a yaw moment of inertia can be decreased.

Further, the engine and the electric generator are arranged inside the floor tunnel, and the engine and the electric generator are arranged in the space other than a front part space of the vehicle. Therefore, a degree of freedom in designing the front part space of the vehicle can be improved (for example, the front part space of the vehicle may be used as a cargo space).

Thereby, the center of gravity can be lowered, the yaw moment of inertia can be decreased, and the degree of freedom in designing the front part space of the vehicle can be improved.

In one embodiment of the invention, the electric generator may be arranged forward from the engine, and an exhaust system of the engine may extend rearward from the engine.

As described above, the electric generator is arranged forward from the engine, and the exhaust system of the engine extends rearward from the engine. Therefore, an emission from the engine to the rear can easily be performed.

Further, the electric generator is arranged forward from the engine, and the exhaust system of the engine extends rearward from the engine. The electric generator, engine, and exhaust system are arranged in this order from the front to the rear. Therefore, the exhaust system does not need to have a complicated structure and, thus, the emission can effectively be performed.

In one embodiment, the structure of the electric vehicle may further include a sub frame having a substantially rectangular frame shape in a plan view, the sub frame having left and right side frames extending along the vehicle front-to-rear axis, a front frame extending along the vehicle width axis and coupled to front end parts of the side frames, and a rear frame extending along the vehicle width axis, rearward from the front frame, and coupled to rear end parts of the side frames. The engine and the electric generator may be attached to the sub frames, and the sub frames to which the engine and the electric generator are attached may be attached to a body of the vehicle so that the respective side frames are arranged along respective side wall parts of the floor tunnel.

As described above, the structure of the electric vehicle further includes the sub frame having the substantially rectangular frame shape in the plan view, and the sub frame has the left and right side frames extending along the vehicle front-to-rear axis, the front frame extending along the vehicle width axis and coupled to front end parts of the side frames, and the rear frame extending along the vehicle width axis, rearward from the front frame, and coupled to rear end parts of the side frames. The engine and the electric generator are attached to the sub frames, and the sub frames to which the engine and the electric generator are attached is attached to the body of the vehicle so that the respective side frames are arranged along the respective side wall parts of the floor tunnel. Therefore, the floor tunnel can be reinforced along the vehicle front-to-rear axis by the side frames of the sub frame, and the floor tunnel can be reinforced along the vehicle width axis by the front frame and rear frame of the sub frame. That is, the sub frame for attaching the engine and the electric generator can also function as a reinforcing member for reinforcing the floor tunnel.

In one embodiment, a cross member extending along the vehicle width axis may be provided rearward from the engine. The battery may be arranged rearward from the cross member. The engine and the battery may be supported by the cross member.

As described above, the cross member extending along the vehicle width axis is provided rearward from the engine. The battery is arranged rearward from the cross member. The engine and the battery are supported by the cross member. Therefore, the single and same cross member can support the engine and the battery, thereby reducing the number of the components.

In one embodiment, an intake system of the engine may extend forward from the engine, pass through the floor tunnel, pass through the front of a dashboard panel, and reach a cowl panel.

As described above, the intake system of the engine extends forward from the engine, passes through the floor tunnel, passes through the front of the dashboard panel, and reaches the cowl panel. Therefore, the intake system is arranged in the space other than the front part space of the vehicle, thereby the degree of freedom in designing the front part space of the vehicle can further be improved.

In one embodiment, the structure of the electric vehicle may further include a fuel tank for the engine, that is arranged forward from the engine and the electric generator, inside the floor tunnel.

As described above, the fuel tank for the engine is arranged forward from the engine and the electric generator, inside the floor tunnel. Therefore, the distance between the fuel tank and the engine can be comparatively small and supply of the fuel from the fuel tank to the engine can easily be performed.

In one embodiment, the battery may be arranged forward from a coupling member for coupling left and right rear wheels that serve as the driving wheels and constituting a part of a suspension, and may be arranged rearward from the engine. The motor may be arranged rearward from the coupling member.

As described above, the battery is arranged forward from the coupling member for coupling the left and right wheels that serve as the driving wheels and constituting the part of the suspension, and is arranged rearward from the engine. Therefore, the battery is arranged comparatively forward of the vehicle rear part, thereby the yaw moment of inertia can further be decreased.

Further, the motor is arranged rearward from the coupling member, the motor is arranged in the space other than the front part space of the vehicle. Therefore, the degree of freedom in designing the front part space of the vehicle can further be improved.

According to another aspect of the invention, a structure of an electric vehicle includes an engine, an electric generator which is driven by the engine, a battery which is supplied and charged with generated power at least from the electric generator, and a motor which is supplied with power from the battery to drive driving wheels. The engine is arranged below a floor panel so that it is located at substantially the same position along the vehicle front-to-rear axis as a seat provided on the floor panel. The electric generator is arranged below the floor panel.

As described above, the engine is arranged below the floor panel at substantially the same position along the vehicle front-to-rear axis as the seat provided on the floor panel, the engine which is comparatively heavy is arranged in the center part of the vehicle along the vehicle front-to-rear axis. Therefore, the center of gravity can be lowered and a yaw moment of inertia can be decreased.

Further, the engine and the electric generator are arranged below the floor panel, the engine and the electric generator are arranged in the space other than the front part space of the vehicle. Therefore, the degree of freedom in designing the front part space of the vehicle can be improved (for example, the front part space of the vehicle may be used as a cargo space).

Thereby, the center of gravity can be lowered, the yaw moment of inertia can be decreased, and the degree of freedom in designing the front part space of the vehicle can be improved.

In one embodiment, the engine may be arranged below a center part of the floor panel along the vehicle width axis.

As described above, the engine is arranged below the center part of the floor panel along the vehicle width axis, the engine, which is comparatively heavy, is arranged in the center part of the vehicle along the vehicle width axis. Therefore the weight, the stability in traveling, and controlling of the vehicle can be improved.

In one embodiment, the engine may be arranged inside a bulged part of the floor panel that is formed so as to be bulged upward in a portion corresponding to the seat.

As described above, the engine is arranged inside the bulged part of the floor panel that is formed so as to be bulged upward in the portion corresponding to the seat. Therefore, a space below the seat can effectively be used.

In one embodiment, the electric generator may be arranged on one side of the engine along the vehicle width axis.

As described above, the electric generator is arranged on one side of the engine along the vehicle width axis. Therefore, the engine and the electric generator can be arranged closely to each other.

In one embodiment, the structure of the electric vehicle may further include a fuel tank for the engine arranged forward from the engine and the electric generator so that at least a part of the fuel tank is located rearward from a dashboard panel, below the floor panel.

When applying a plug-in hybrid vehicle equipped with a downsized engine, the fuel tank for the engine can be downsized. Further, according to the above embodiment, when the fuel tank is downsized, the fuel tank can be arranged forward from the engine and the electric generator so that at least a part of the fuel tank is located rearward from the dashboard panel, below the floor panel.

In one embodiment, the fuel tank may be supported by a dashboard cross member, below the dashboard cross member that is provided forward from the dashboard panel so as to extend along the vehicle width axis.

As described above, the fuel tank is supported by the dashboard cross member, below the dashboard cross member that is provided forward from the dashboard panel so as to extend along the vehicle width axis. Therefore, the fuel tank can be supported by the existing dashboard cross member, thereby reducing the number of the components.

In one embodiment, a portion of the floor panel corresponding to the seat may be formed so that an upper surface of a front part of the portion is formed higher than an upper surface of a rear part of the portion, a driving shaft of the engine may be arranged so as to be oriented along the vehicle vertical axis and located below the front portion of the floor panel corresponding to the seat, and a rotation shaft of the electric generator may be arranged so as to be oriented along the vehicle vertical axis.

As described above, the portion of the floor panel corresponding to the seat is formed so that the upper surface of the front part of the portion is formed higher than the upper surface of the rear part of the portion. Therefore, if the seat is a front seat, a leg space for a person sitting on a rear seat can be secured because of the rear part of the floor panel, of which the upper surface is relatively low, corresponding to the seat.

In one embodiment, the engine and the electric generator may be attached to a sub frame. The sub frame to which the engine and the electric generator are attached may be attached to left and right side frames provided below the floor panel so as to extend along the vehicle front-to-rear axis.

As described above, the sub frame to which the engine and the electric generator are attached is attached to the left and right side frames provided below the floor panel so as to extend along the vehicle front-to-rear axis. Therefore, at the time of an offset frontal collision, an impact load applied to one of the side frames can be transmitted via this sub frame to the other side frame, and the impact load applied at the time of the offset frontal collision can be dispersed.

In one embodiment, the engine may be arranged at substantially the same position along the vehicle front-to-rear axis as a front seat provided on the floor panel. The battery may be arranged below a rear seat provided on the floor panel, rearward from the front seat.

When the fuel tank is arranged in a part other than below the rear seat where the fuel tank is normally arranged, the battery can be arranged below the rear seat.

In one embodiment, the battery may be supported by a first cross member provided forward from the battery and extending along the vehicle width axis, and a second cross member provided rearward from the battery and extending along the vehicle width axis.

As described above, the battery is supported by the first cross member provided forward from the battery and extending along the vehicle width axis, and the second cross member provided rearward from the battery and extending along the vehicle width axis. Therefore, the battery can be supported stably by the first and second cross members with comparatively high rigidity.

According to another aspect of the invention, a structure of an electric vehicle includes an engine, an electric generator which is driven by the engine, a battery which is supplied and charged with generated power at least from the electric generator, and a motor which is supplied with power from the battery to drive driving wheels. The engine is arranged below a floor panel, in a center part of the vehicle along the vehicle front-to-rear axis. The electric generator is arranged below the floor panel.

As described above, the engine is arranged below the floor panel, in the center part of the vehicle along the vehicle front-to-rear axis. Therefore, the engine and the electric generator which are comparatively heavy are arranged in the center part of the vehicle along the vehicle front-to-rear axis. Therefore, the center of gravity can be lowered and a yaw moment of inertia can be decreased.

Further, the engine and the electric generator are arranged below the floor panel, the engine and the electric generator are arranged in the space other than a front part space of the vehicle. Therefore, a degree of freedom in designing the front part space of the vehicle can be improved, for example, the front part space of the vehicle can be used as a cargo space.

Thereby, the center of gravity can be lowered, the yaw moment of inertia can be decreased, and the degree of freedom in designing the front part space of the vehicle can be improved.

### BRIEF DESCRIPTION OF THE DRAWINGS

FIG. 1 is a block diagram schematically showing a drive system of an electric vehicle according to a first embodiment of the present invention.

FIG. 2 is a side view schematically showing the entire structure of the electric vehicle according to the first embodiment of the invention.

FIG. 3 is a plan view schematically showing the entire structure of the electric vehicle according to the first embodiment of the invention.

FIG. 4 is a perspective view schematically showing a structure of a floor tunnel according to the first embodiment of the invention.

FIG. 5 is a bottom view schematically showing a supporting structure of a battery to No. 3 and No. 4 cross members according to the first embodiment of the invention.

FIG. 6 is a front view schematically showing a supporting structure of a fuel tank to a dashboard cross member according to the first embodiment of the invention.

FIG. 7 is a side view schematically showing the supporting structure of the fuel tank to the dashboard cross member according to the first embodiment of the invention.

FIG. 8 is a cross-sectional view taken along a line VIII-VIII of FIG. 3.

FIG. 9 is a cross-sectional view taken along a line IX-IX of FIG. 3.

FIG. 10 is a cross-sectional view taken along a line X-X of FIG. 3.

FIG. 11 is an exploded perspective view schematically showing an attaching structure of an engine and a generator to a sub frame according to the first embodiment of the invention.

FIG. 12 is a block diagram schematically showing a drive system of an electric vehicle according to a second embodiment of the present invention.

FIG. 13 is a side view schematically showing the entire structure of the electric vehicle according to the second embodiment of the invention.

FIG. 14 is a plan view schematically showing the entire structure of the electric vehicle according to the second embodiment of the invention.

FIG. 15 is a perspective view schematically showing a structure of a floor tunnel according to the second embodiment of the invention.

FIG. 16 is a bottom view schematically showing a supporting structure of a battery to No. 3 and No. 4 cross members according to the second embodiment of the invention.

FIG. 17 is a front view schematically showing a supporting structure of a fuel tank to a dashboard cross member according to the second embodiment of the invention.

FIG. 18 is a schematic side view showing the supporting structure of the fuel tank to the dashboard cross member according to the second embodiment of the invention.

FIG. 19 is a cross-sectional view taken along a line VIII-VIII of FIG. 14.

FIG. 20 is a cross-sectional view taken along a line IX-IX of FIG. 14.

FIG. 21 is a cross-sectional view taken along a line X-X of FIG. 14.

FIG. 22 is an exploded perspective view schematically showing an attaching structure of an engine and a generator to a sub frame according to the second embodiment of the invention.

### DETAILED DESCRIPTION OF THE EMBODIMENTS

Hereinafter, embodiments of the present invention are described with reference to the appended drawings.

### Embodiment 1

### Configuration of Driving System of Electric Vehicle

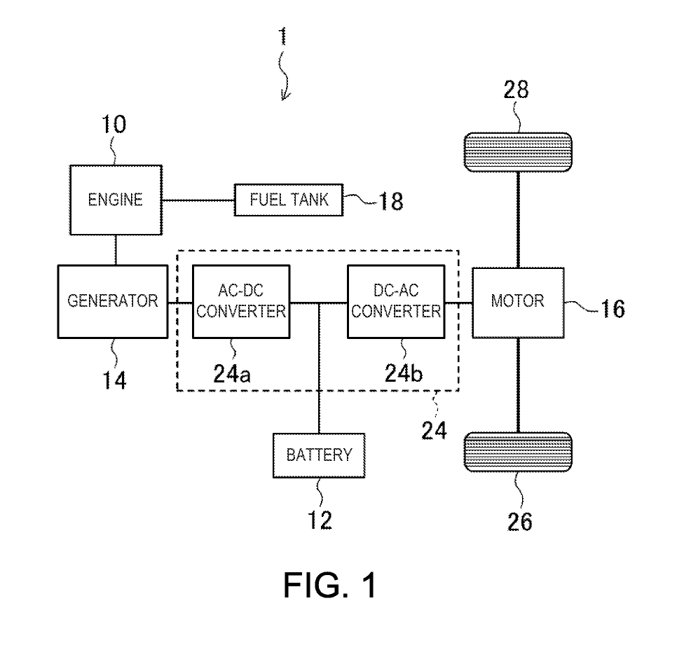

FIG. 1 is a block diagram schematically showing a driving system of an electric vehicle equipped with an engine according to a first embodiment of the present invention. An electric vehicle 1 of this embodiment (hereinafter, may also be referred to as “the vehicle”) is a plug-in hybrid vehicle in which, when traveling a short distance (e.g., when traveling 50 km or shorter), power in a battery 12 charged by being supplied with external power from an external power source such as a home power source is supplied to a motor 16 to drive driving wheels, and, on the other hand, when traveling a long distance, a generator 14 (electric generator) is driven by an engine 10, the generated power is supplied to the battery 12 for charging, and the charged power in the battery 12 is supplied to the motor 16 to drive the driving wheels. This plug-in hybrid vehicle is a series hybrid vehicle including the engine 10 and the motor 16 as its power sources as described above. The engine 10 is only used for the power generation and all the motive force for the vehicle 1 to move is relied on the motor 16.

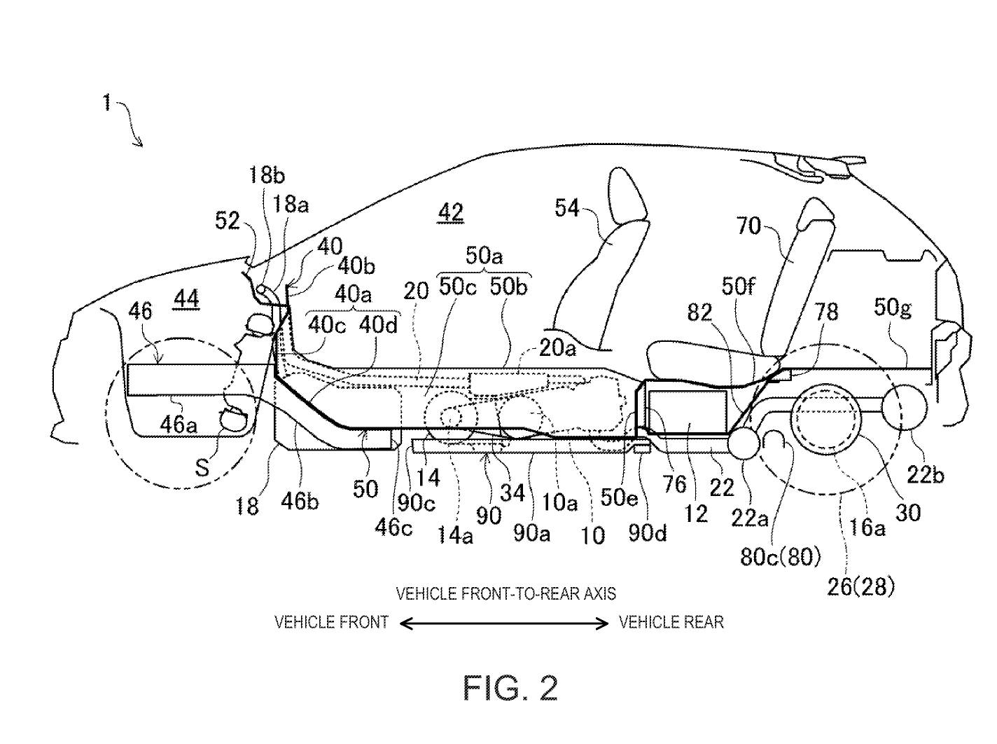

The engine 10 is a compact reciprocating engine having a single cylinder (hereinafter, may also be referred to as “the cylinder”). In this reciprocating engine, a fuel (e.g., gasoline) supplied from a fuel tank 18 for the engine is combusted in a combustion chamber to obtain energy, then a piston inside the cylinder is vertically moved by the energy, and the linear movement is converted into a rotary movement by a connecting rod and a crank shaft 10a (a driving shaft illustrated in FIG. 2 and other figures). The cylinder is communicated with an intake passage 20 (intake pipe) (corresponding to an “intake system of the engine” illustrated in FIG. 2 and other figures) and an exhaust passage 22 (exhaust pipe) (corresponding to an “exhaust system of the engine” illustrated in FIG. 2 and other figures). In the intake passage 20, an air cleaner 20a using a filter for removing foreign matters and dusts in intake air is provided. In the exhaust passage 22, an exhaust emission control device 22a using a three-way catalyst for purifying hazardous components in exhaust gas, such as HC, CO and NOx, is provided, and a muffler 22b for cancelling out a pressure variation of the energy generated by the explosion sound of the exhaust gas and absorbing the energy to reduce the sound is provided downstream of the exhaust emission control device 22a. When a remaining battery level of the battery 12 is low (for example, when a state of charge SOC of the battery 12 becomes 30% or lower), the engine 10 is automatically operated. Note that, as described above, because the engine 10 is downsized, the fuel tank 18 and the air cleaner 20a are also downsized.

The battery 12 is a large-sized and large-capacity battery with high performance. The battery 12 is connected to the generator 14 and the motor 16 via an inverter 24, respectively, and is supplied and charged with the generated power from the generator 14 and regenerated power from the motor 16. Then, the battery 12 supplies the power to the motor 16 to drive the same. Further, when the vehicle 1 is not used, the battery 12 can be supplied and charged with the external power from the external power source.

The generator 14 is coupled to the crank shaft 10a of the engine 10 by its rotation shaft 14a (input shaft) (illustrated in FIG. 2 and other figures) and can be driven by the engine 10.

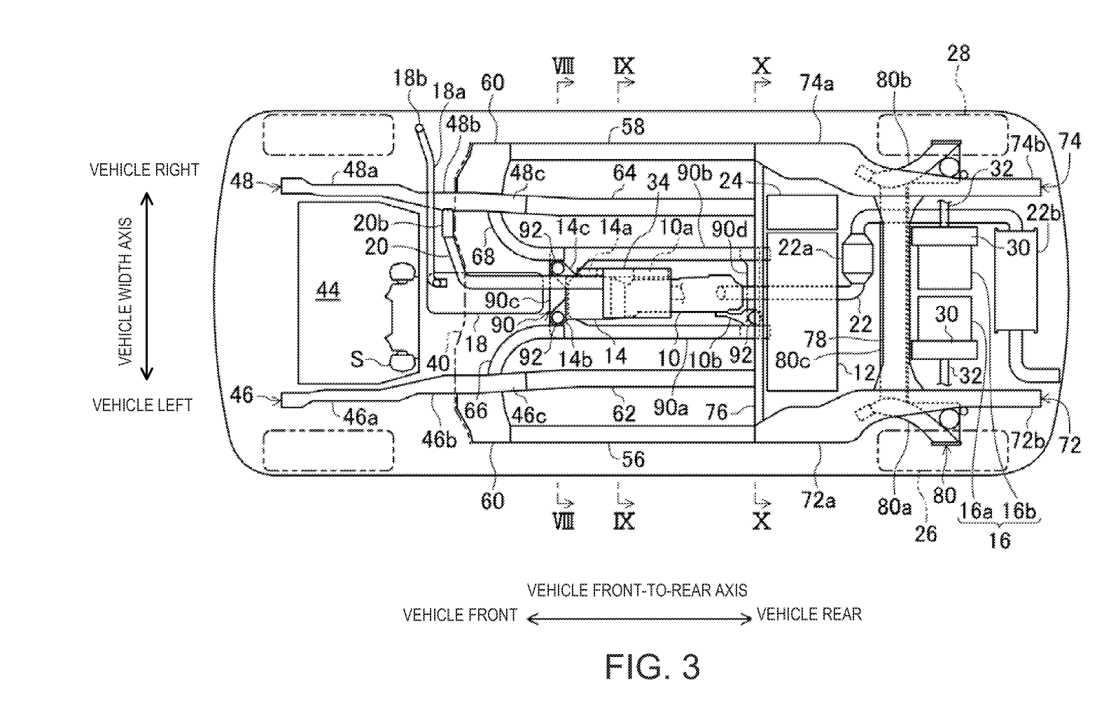

The motor 16 is constituted with a left rear wheel motor 16a (illustrated in FIG. 2 and other figures) and a right rear wheel motor 16b (illustrated in FIG. 3). The left rear wheel motor 16a is coupled to a left rear wheel 26 as the driving wheel via a final gear 30 and a driving shaft 32 (drive shaft) (illustrated in FIG. 3) by its rotation shaft (output shaft), and, by being supplied with the power from the battery 12 and/or the generator 14, it drives the left rear wheel 26. The right rear wheel motor 16b is coupled to a right rear wheel 28 as the driving wheel via the final gear 30 and the driving shaft 32 by its rotation shaft, and, by being supplied with the power from the battery 12 and/or the generator 14, it drives the right rear wheel 28. The final gear 30 ultimately reduces the rotational speed of the motors 16a and 16b and transmits the motive force of the motors 16a and 16b to the rear wheels 26 and 28, respectively.

The inverter 24 is integrally formed with an AC-DC converter 24a (an inverter for the generator 14) for converting an AC power into a DC power and a DC-AC converter 24b (an inverter for the motor 16) for converting a DC power into an AC power, to perform mutual transfers and conversions of power among the battery 12, the generator 14, and the motor 16. Specifically, when charging the battery 12 with the power from the generator 14, the AC power from the generator 14 is converted into the DC power by the AC-DC converter 24a to be supplied to the battery 12. Alternatively, when supplying the power from the battery 12 to the motor 16, the DC power from the battery 12 is converted into the AC power by the DC-AC converter 24b to be supplied to the motor 16. Moreover, when supplying the power from the generator 14 to the motor 16, the AC power from the generator 14 is converted into the DC power by the AC-DC converter 24a, and the DC power is then converted into the AC power by the DC-AC converter 24b to be supplied to the motor 16.

### Entire Structure of Electric Vehicle

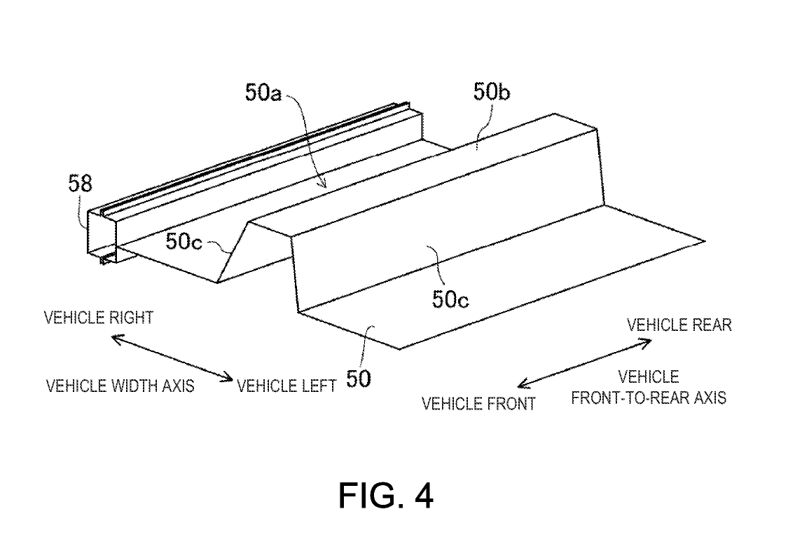

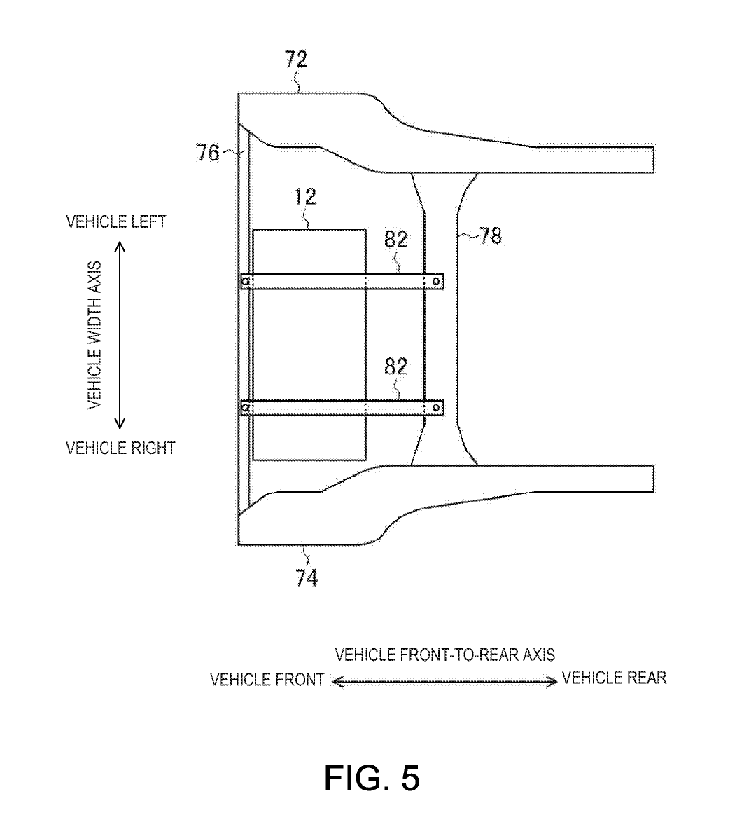

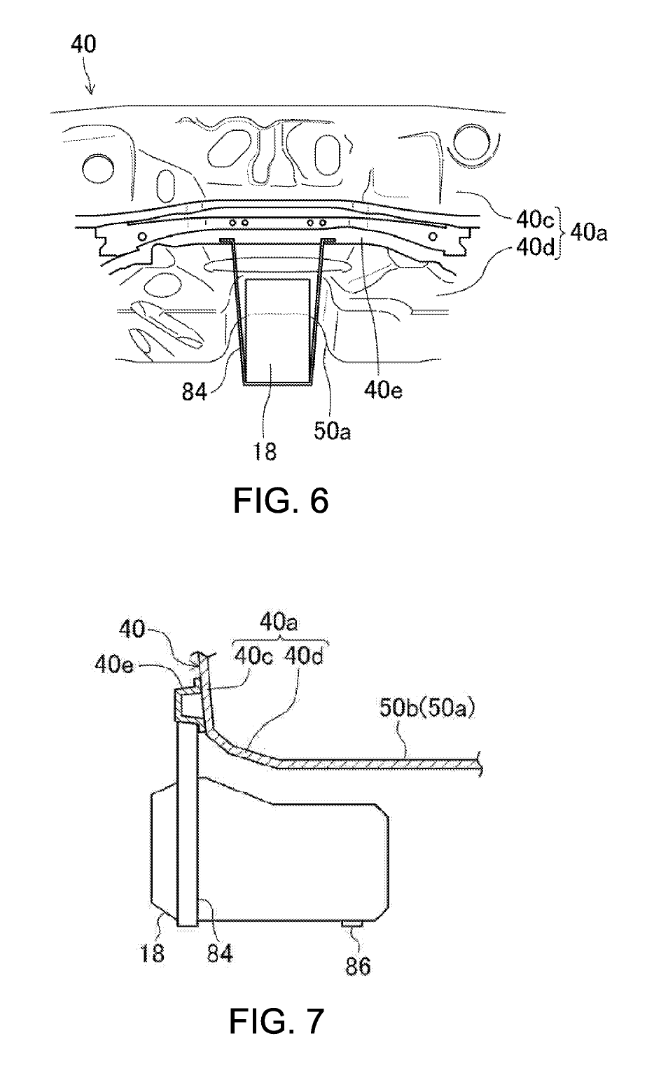

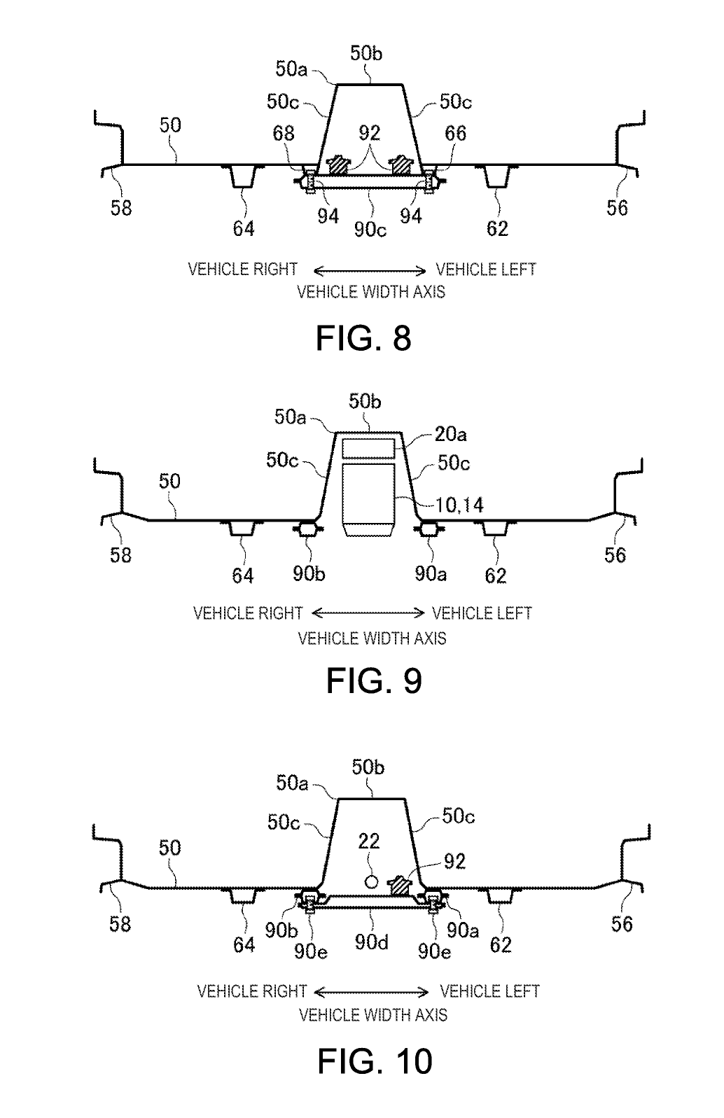

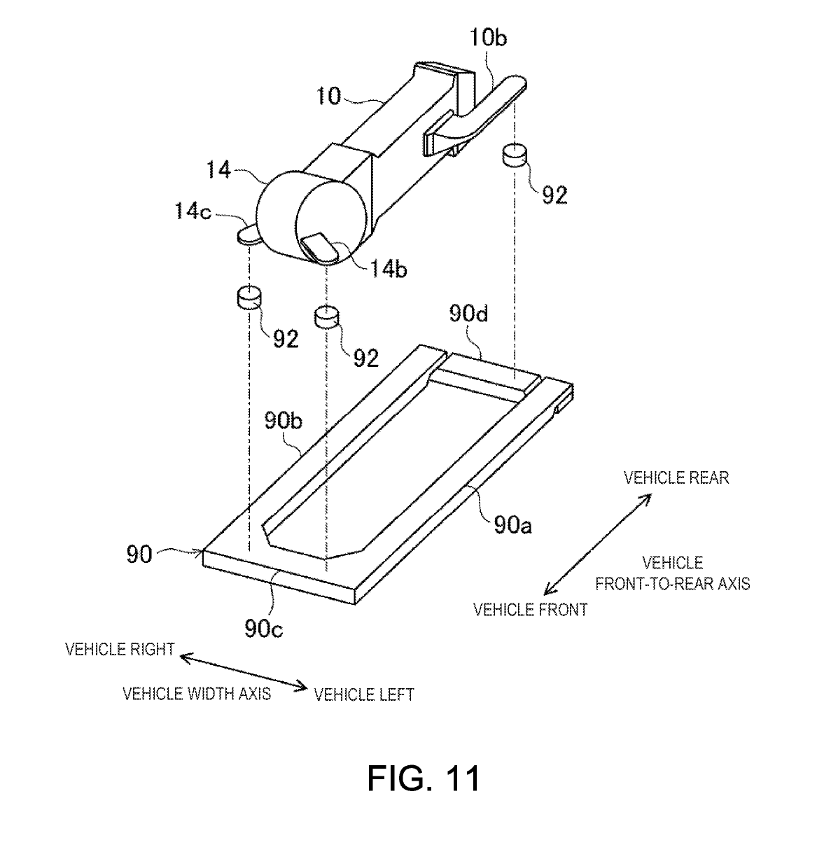

Hereinafter, the entire structure of the electric vehicle 1 is described. FIG. 2 is a side view schematically showing the entire structure of the electric vehicle. FIG. 3 is a plan view schematically showing the entire structure of the electric vehicle. FIG. 4 is a perspective view schematically showing a structure of a floor tunnel. FIG. 5 is a bottom view schematically showing a supporting structure of a battery to No. 3 and No. 4 cross members. FIG. 6 is a front view schematically showing a supporting structure of a fuel tank to a dashboard cross member. FIG. 7 is a side view schematically showing the supporting structure of the fuel tank to the dashboard cross member. FIG. 8 is a cross-sectional view taken along a line VIII-VIII of FIG. 3. FIG. 9 is a cross-sectional view taken along a line IX-IX of FIG. 3. FIG. 10 is a cross-sectional view taken along a line X-X of FIG. 3. FIG. 11 is an exploded perspective view schematically showing an attaching structure of the engine and the generator to the sub frame. Note that, in these figures, for easier view of the drawings, illustrations of the components are suitably omitted or simplified.

First, the structure of the vehicle body is described.

A vehicle front space in front of a dashboard panel 40 (a front space of the vehicle 1) which is partitioned from a vehicle cabin 42 by the dashboard panel 40 is formed in the front part of the vehicle 1 as a cargo space 44. A spare tire S is accommodated in a left rear part of the cargo space 44.

Left and right front side frames 46 and 48 are arranged on both sides of the cargo space 44 along the vehicle width axis and extend along the vehicle front-to-rear axis, respectively. These front side frames 46 and 48 include first horizontal parts 46a and 48a extending along the vehicle front-to-rear axis in front of the lower dashboard panel 40, inclined parts 46b and 48b extending obliquely downward and rearward from rear ends of the first horizontal parts 46a and 48a along a front surface of an inclined wall part 40d of a lower dashboard part 40a (described later), and second horizontal parts 46c and 48c extending rearward from rear ends of the inclined parts 46b and 48b along a lower surface of a floor panel 50 for forming a bottom surface of the cabin 42.

The dashboard panel 40 includes the lower dashboard part 40a standing upward from a front end of the floor panel 50 and extending along the vehicle width axis, and an upper dashboard part 40b extending upward from an upper end of the lower dashboard part 40a. The lower dashboard part 40a includes a vertical wall part 40c extending along the vertical axis and the inclined wall part 40d extending obliquely downward and rearward from a lower end of the vertical wall part 40c and coupled to the front end of the floor panel 50. A dashboard cross member 40e extending along the vehicle width axis and coupled to respective rear end parts of the first horizontal parts 46a and 48b of the front side frames 46 and 48 is provided in a front surface of a lower end part of the vertical wall part 40c. A cowl panel 52 opening upward between a hood and a front wind shield is provided to the upper dashboard part 40b to extend along the vehicle width axis.

On the front part of the floor panel 50, a front seat 54 where a driver's seat and a front passenger seat are arranged along the vehicle width axis so as to be spaced therebetween. On both sides of the floor panel 50 along the vehicle width axis, left and right side sills 56 and 58 are arranged next to the cabin 42 (below the doors) to extend along the vehicle front-to-rear axis, respectively. These side sills 56 and 58 are coupled to respective connecting parts between the inclined part 46a and 48b and the second horizontal parts 46c and 48c of the front side frames 46 and 48 at the front ends thereof via respective coupling members 60 extending along the vehicle width axis.

On the lower surface of the floor panel 50, left and right B-frames 62 and 64 are arranged inward from the respective side sills 56 and 58 along the vehicle width axis to extend along the vehicle front-to-rear axis. These B-frames 62 and 64 are for improving the rigidity of the floor panel 50. Front ends of the B-frames 62 and 64 are coupled to rear ends of the second horizontal parts 46c and 48c of the front side frames 46 and 48.

On the lower surface of the floor panel 50, left and right curved frames 66 and 68 (corresponding to the “body of the vehicle” in the claims) are arranged inward from the respective front side frames 46 and 48 along the vehicle width axis. These curved frames 66 and 68 are for dispersing an impact load at the time of a vehicle collision, and they curve rearward from the inner faces of the second horizontal parts 46c and 48c of the front side frames 46 and 48 along the vehicle width axis and extend to respective front end part positions of the B-frames 62 and 64 along the vehicle front-to-rear axis.

In the center part of the floor panel 50 along the vehicle width axis, a floor tunnel 50a is formed in a substantially trapezoidal cross-sectional shape so as to bulge upwardly (a raise). Inward of the B-frames 62 and 64 along the vehicle width axis, the floor tunnel 50a extends rearward inside the cabin 42 from the lower dashboard part 40a and reaches a kick up part 50e (described later). Further, the floor tunnel 50a is formed so that an upper surface of an upper wall part 50b extends substantially along the horizontal axis.

Rearward from the center part of the floor panel 50 along the vehicle front-to-rear axis, the kick up part 50e is formed to stand upward and a rear floor panel 50f is formed from the upper end of the kick up part 50e to extend rearward. A bench-type rear seat 70 is provided on a front part of a rear floor panel 50f. A cargo room floor 50g is formed rearward from the rear seat 70 on the rear floor panel 50f. That is, the cargo room floor 50g constitutes the rear part of the rear floor panel 50f.

Left and right rear side frames 72 and 74 are provided on the lower surface of both end parts of the rear floor panel 50f along the vehicle width axis and extend along the vehicle front-to-rear axis. These rear side frames 72 and 74 include inclined parts 72a and 74a incline upward as they go rearward and horizontal parts 72b and 74b extending rearward from rear ends of the inclined parts 72a and 74a. The front ends of the inclined parts 72a and 74a are coupled to rear ends of the side sills 56 and 58, respectively.

A No. 3 cross member 76 (corresponding to the “body of the vehicle” in the claims) extending along the vehicle width axis below a front end part of the rear floor panel 50f and coupled to front end parts of the rear side frames 72 and 74 is provided on the back surface of the kick up part 50e. A No. 4 cross member 78 extending along the vehicle width axis, rearward from the No. 3 cross member 76, and coupled to center parts of the rear side frames 72 and 74 along the vehicle front-to-rear axis (respective connecting parts between the inclined parts 72a and 74a and the horizontal parts 72b and 74b of the rear side frames 72 and 74) is provided on the lower surface of the center part of the rear floor panel 50f along the vehicle front-to-rear axis. Rear ends of the B-frames 62 and 64 are coupled to both sides of the No. 3 cross member 76 along the vehicle width axis. A lower surface of the No. 4 cross member 78 is located higher than a lower surface of the No. 3 cross member 76.

As for the rear wheels 26 and 28, a torsion-beam suspension 80 in which left and right trailing arms 80a and 80b are connected with each other by a beam referred to as a cross beam 80c is adopted in this embodiment. The cross beam 80c is arranged below the center part of the rear floor panel 50f along the vehicle front-to-rear axis (below the No. 4 cross member 78) and extends along the vehicle width axis so that it is located forward from the wheel axles at the center of the rear wheels 26 and 28 and rearward from front ends of the rear wheels 26 and 28, in the vehicle side view. That is, the cross beam 80c constitutes a coupling member for coupling the left and right rear wheels 26 and 28 and constitutes a part of the suspension 80.

Next, the arrangement of the engine 10 and the generator 14 is described.

The engine 10 is arranged so that the crank shaft 10a extends along the vehicle width axis inside the floor tunnel 50a. Specifically, the engine 10 is provided at substantially the same position along the vehicle front-to-rear axis as the front seat 54 inside the floor tunnel 50a along the vehicle front-to-rear axis so that the cylinder head side is oriented rearward and the intake side upward. That is, the engine 10 is arranged at a position in the floor panel 50 corresponding to the center part of the vehicle 1 along the vehicle front-to-rear axis.

The battery 12 is arranged forward from the cross beam 80c, below the rear floor panel 50f. That is, the battery 12 is arranged below the front part of the rear floor panel 50f, in other words, below a position of the rear floor panel 50f where the rear seat 70 is arranged. Further, the battery 12 is supported by the No. 3 cross member 76 provided near the front of the battery 12 and the No. 4 cross member 78 provided to the rear of the battery 12. More specifically, the battery 12 is supported from below by two band-shaped members 82 bridged between the lower surface of the No. 3 cross member 76 and the lower surface of the No. 4 cross member 78, so as to be spaced along the vehicle width axis.

The generator 14 is arranged closely to the engine 10 so that the rotation shaft 14a extends along the vehicle width axis, in front of the engine 10 inside the floor tunnel 50a. The rotation shaft 14a of the generator 14 is coupled to the crank shaft 10a of the engine 10 via a belt 34 in parallel. The belt 34 is arranged on the right surface sides of the engine 10 and the generator 14. Further, the generator 14 is integrally coupled to the front part of the engine 10, and thereby the engine 10 and the generator 14 constitute an assembly.

The left rear wheel motor 16a is integrally coupled to the final gear 30 and is arranged so that the rotation shaft thereof extends along the vehicle width axis below and leftward from the front part of the cargo room floor 50g. The right rear wheel motor 16b is integrally coupled to the final gear 30 and is arranged so that the rotation shaft thereof extends along the vehicle width axis below the right front part of the cargo room floor 50g. That is, the left rear wheel motor 16a and the right rear wheel motor 16b are arranged side by side along the vehicle width axis, rearward from the cross beam 80c.

The fuel tank 18 is arranged in front of the engine 10 and the generator 14 inside the floor tunnel 50a. Specifically, the rear part of the fuel tank 18 is located inside the floor tunnel 50a, forward from the engine 10 and the generator 14. Further, the fuel tank 18 is arranged below the dashboard cross member 40e and supported by the dashboard cross member 40e. Specifically, the front part of the fuel tank 18 is held and supported by a substantially U-shaped belt-shaped member 84 suspended from the center part of the dashboard cross member 40e along the vehicle width axis, while the rear part of the fuel tank 18 is supported from below by a belt-shaped member 86 of a substantially flat plate shape bridged between front end parts of the B-frames 62 and 64. A fuel refilling pipe 18a of the fuel tank 18 extends rightward from the front end part of the fuel tank 18 and a fuel refilling port 18b thereof opens toward a right front fender.

The intake passage 20 starts from the engine 10, passes through the floor tunnel 50e, and reaches the cowl panel 52, and an intake port 20b thereof opens to the cowl panel 52 toward the outside of the vehicle. Specifically, the intake passage 20 extends forward from the rear upper part of the engine 10 and reaches a position above the fuel tank 18, and further passes between the fuel tank 18 and the upper wall part 50b of the floor tunnel 50a to reach a position in front of the dashboard panel 40. Further, the intake passage 20 passes through the front side of the dashboard panel 40 (along the front surface of the dashboard panel 40), extends obliquely upward to the right, and reaches the cowl panel 52. The intake passage 20 takes the captured outside air into the cowl panel 52, and further into the engine 10. The air cleaner 20a is arranged above the front part of the engine 10, inside the floor tunnel 50a.

The exhaust passage 22 extends rearward from the engine 10, below the floor panel 50. Specifically, the exhaust passage 22 passes between above a rear frame 90d of a sub frame 90 (described later) and below the battery 12 from the rear lower part of the engine 10, extends rearward to reach a position rearward from the battery 12, and, further, the exhaust passage 22 extends rightward to reach a position rearward from the inverter 24. Further, the exhaust passage 22 extends rearward to reach a position rearward from the driving shaft 32 of the right rear wheel 28. Next, the exhaust passage 22 extends leftward to reach a position rearward from the driving shaft 32 of the left rear wheel 26 and it further extends rearward. The exhaust emission control device 22a is arranged obliquely downward and rearward from the battery 12 located below and forward of the front part of the rear floor panel 50f. The muffler 22b is arranged rearward from the right rear wheel motor 16b located below and rearward of the cargo room floor 50g. The inverter 24 is arranged closely to the battery 12, rightward from the battery 12 located below and leftward of the front part of the rear floor panel 50f.

As described above, the generation module constituted with the engine 10, the generator 14, and the fuel tank 18 is arranged in the center part of the vehicle 1, and the electric driving module constituted with the battery 12, the motor 16, and the inverter 24 is arranged in the rear part of the vehicle 1, so that they are separately arranged. Thereby, harnesses and piping can be simplified and the weight distribution of the vehicle 1 can be properly adjusted.

The engine 10 and the generator 14 are attached to the sub frame 90 of the substantially rectangular frame shape in the plan view. Hereinafter, the attaching structure is described in detail.

The sub frame 90 includes left and right side frames 90a and 90b extending along the vehicle front-to-rear axis, a front frame 90c extending along the vehicle width axis and coupled to front end parts of the side frames 90a and 90b, and the rear frame 90d extending in parallel with the front frame 90c and coupled to respective rear end parts of the side frames 90a and 90b, rearward from the front frame 90c. The side frames 90a and 90b and the front frame 90c are integrally formed. Each lower surface of rear end parts of the side frames 90a and 90b is recessed upward. Each upper surface of both the left and right end parts of the rear frame 90d is recessed downward, and the recessed parts of the side frames 90a and 90d are fixedly fastened by a fastening member 90e to the upper surfaces thereof. The side frames 90a and 90b are longer than the front and rear frames 90c and 90d. Among four corner parts of the sub frame 90, two corner parts on the front side protrude inward of the sub frame 90 and each of the left and right protruded parts is formed to be a substantially triangular shape.

The integrally-coupled engine 10 and generator 14 are elastically supported by the upper surface of the left end part of the rear frame 90d via a bracket 10b provided to the left rear part of the engine 10 and a rubber mount 92, by the upper surface of the left end part of the front frame 90c via a bracket 14b provided to the left front part of the generator 14 and a rubber mount 92, and by the upper surface of the right end part of the front frame 90d via a bracket 14c provided to the right front part of the generator 14 and a rubber mount 92.

The sub frame 90 to which the engine 10 and the generator 14 are attached is attached to the curved frames 66 and 68, and the No. 3 cross member 76 so that the side frames 90a and 90b of the sub frame 90 are arranged along lower edges of the side wall parts 50c of the floor tunnel 50a (side edge parts of the downward opening of the floor tunnel 50a), respectively, and the front and rear frames 90c and 90d are bridged between the lower edges of the side wall parts 50c, respectively. That is, after the engine 10 and the generator 14 are attached to the sub frame 90, the sub frame 90 to which the engine 10 and the generator 14 are attached is attached to the curved frames 66 and 68, and the No. 3 cross member 76. Additionally, the engine 10 is supported by the No. 3 cross member 76 via the sub frame 90. Specifically, the two corner parts on the front side among the four corner parts of the sub frame 90 are fixedly fastened to the lower surfaces of the rear end parts of the curved frames 66 and 68 by a fastening member 94, while the other two corner parts on the rear side are attached to the lower surface of the No. 3 cross member 76. Thus, by attaching to the curved frames 66 and 68 the sub frame 90 to which the engine 10 and the generator 14 are attached, and the No. 3 cross member 76, the engine 10 and the generator 14 are arranged inside the floor tunnel 50a, as described above. Further, as described above, by arranging the side frames 90a and 90b along the lower edges of the side wall parts 50c of the floor tunnel 50a, the side frames 90a and 90b function as tunnel members for suppressing the floor tunnel 50a from deforming at the time of a collision of the vehicle 1. Moreover, as described above, by bridging the front and rear frames 90c and 90d between the lower edges of the side wall parts 50c, the front and rear frames 90c and 90d function as tunnel cross members for suppressing the floor panel 50 and the floor tunnel 50a from opening outward along the vehicle width axis. Additionally, the front and rear frames 90c and 90d function as members for receiving the impact load at the time of a side collision of the vehicle 1. That is, the front and rear frames 90c and 90d also function as cross members of the vehicle body.

As described above, the engine 10 and the generator 14 are attached to and supported by the vehicle body.

### Effects

Thereby, in this embodiment, the engine 10 and the generator 14 are arranged inside the floor tunnel 50a, the engine 10 and the generator 14 which are comparatively heavy are arranged in the center part of the vehicle 1 along the vehicle front-to-rear axis. Therefore, the center of gravity of the vehicle can be lowered and a yaw moment of inertia can be decreased.

Further, the engine 10 and the generator 14 are arranged inside the floor tunnel 50a, the engine 10 and the generator 14 are arranged in the space other than the front part space of the vehicle 1. Therefore, a degree of freedom in designing the front part space of the vehicle 1 can be improved (for example, the front part space of the vehicle 1 may be used as the cargo space 44).

Thereby, the center of gravity can be lowered, the yaw moment of inertia can be decreased, and the degree of freedom in designing the front part space of the vehicle 1 can be improved.

Further, the engine 10 and the generator 14 are arranged inside the floor tunnel 50a, the engine 10 and the generator 14 are arranged in the center part of the vehicle 1 along the vehicle width axis. Therefore, the rolling moment can be decreased and the drivability of the vehicle can be improved.

Further, the generator 14 is arranged forward from the engine 10 and the exhaust passage 22 of the engine 10 extends rearward from the engine 10. Therefore, an emission from the engine 10 to the rear can easily be performed.

Further, the generator 14 is arranged forward from the engine 10 and the exhaust passage 22 of the engine 10 extends rearward from the engine 10. The generator 14, engine 10, and exhaust passage 22 are arranged in this order from the front to the rear. Therefore, the exhaust passage 22 does not need to have a complicated structure and, thus, the emission can effectively be performed.

Further, the vehicle structure further includes the sub frame 90 of the substantially rectangular frame shape in the plan view, and the sub frame 90 has the left and right side frames 90a and 90b extending along the vehicle front-to-rear axis, the front frame 90c extending along the vehicle width axis and coupled to the front end parts of the side frames 90a and 90b, and the rear frame 90d extending along the vehicle width axis, rearward from the front frame 90c, and coupled to the rear end parts of the side frames 90a and 90b. The engine 10 and the generator 14 are attached to the sub frame 90, and the sub frame 90 to which the engine 10 and the generator 14 are attached is attached to the curved frames 66 and 68, and the No. 3 cross member 76 so that the side frames 90a and 90b are arranged along the respective side wall parts 50c of the floor tunnel 50a. Therefore, the floor tunnel 50a can be reinforced along the vehicle front-to-rear axis by the side frames 90a and 90b of the sub frame 90, and the floor tunnel 50a can be reinforced along the vehicle width axis by the front frame 90c and rear frame 90d of the sub frame 90. That is, the sub frame 90 for attaching the engine 10 and the generator 14 can also function as the reinforcing member for reinforcing the floor tunnel 50a.

Further, the No. 3 cross member 76 extending along the vehicle width axis is provided rearward from the engine 10, and the battery 12 is arranged rearward from the No. 3 cross member 76. In addition, the engine 10 and the battery 12 are supported by the No. 3 cross member 76. Therefore, the single and same cross member 76 can support the engine 10 and the battery 12, thereby reducing the number of the components.

Further, the intake passage 20 of the engine 10 extends forward from the engine 10, passes through the floor tunnel 50a, and further passes through the front side of the dashboard panel 40, and reaches the cowl panel 52. Therefore, the intake passage 20 is arranged in the space other than the front part space of the vehicle 1, thereby the degree of freedom in designing the front part space of the vehicle 1 can further be improved.

Further, the fuel tank 18 for the engine 10 is arranged forward from the engine 10 and the generator 14, inside the floor tunnel 50a. Therefore, the distance between the fuel tank 18 and the engine 10 can be comparatively small and supplying the fuel from the fuel tank 18 to the engine 10 can easily be performed.

Further, the battery 12 is arranged rearward from the engine 10 and forward from the cross beam 80c for coupling the left and right rear wheels 26 and 28 and constitutes the part of the suspension 80. Therefore, the battery 12 is arranged comparatively forward of the rear part of vehicle 1, thereby the yaw moment of inertia can further be decreased.

Moreover, the motor 16 is arranged rearward from the cross beam 80c, the motor 16 is arranged in the space other than the front part space of the vehicle 1. Therefore, the degree of freedom in designing the front part space of the vehicle 1 can further be improved.

### Embodiment 2

Next, another embodiment of the present invention is described in detail with reference to the appended drawings.

### Configuration of Driving System of Electric Vehicle

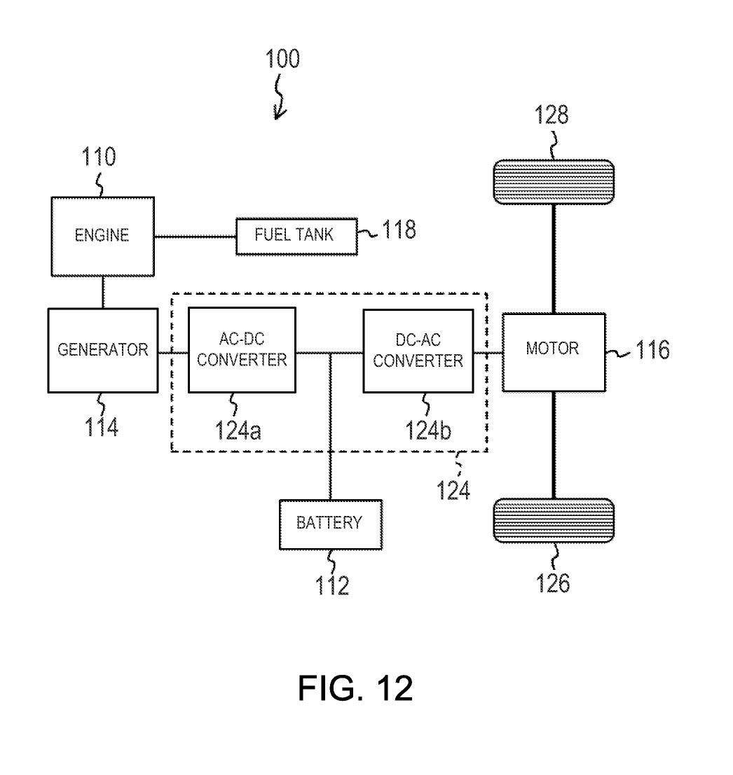

FIG. 12 is a block diagram schematically showing a driving system of an electric vehicle equipped with an engine according to a second embodiment of the invention, similar to the first embodiment. An electric vehicle 100 of this embodiment (hereinafter, may also be referred to as “the vehicle”) is a plug-in hybrid vehicle in which, when traveling a short distance (e.g., when traveling 50 km or shorter), power in a battery 112 charged by being supplied with external power from an external power source such as a home power source is supplied to a motor 116 to drive driving wheels, and, on the other hand, when traveling a long distance, a generator 114 (electric generator) is driven by an engine 110, the generated power is supplied to the battery 112 for charging, and the charged power in the battery 112 is supplied to the motor 116 to drive the driving wheels. This plug-in hybrid vehicle is a series hybrid vehicle including the engine 110 and the motor 116 as its power sources as described above. The engine 110 is only used for the power generation and all the motive force for the vehicle 100 to move relies on the motor 116.

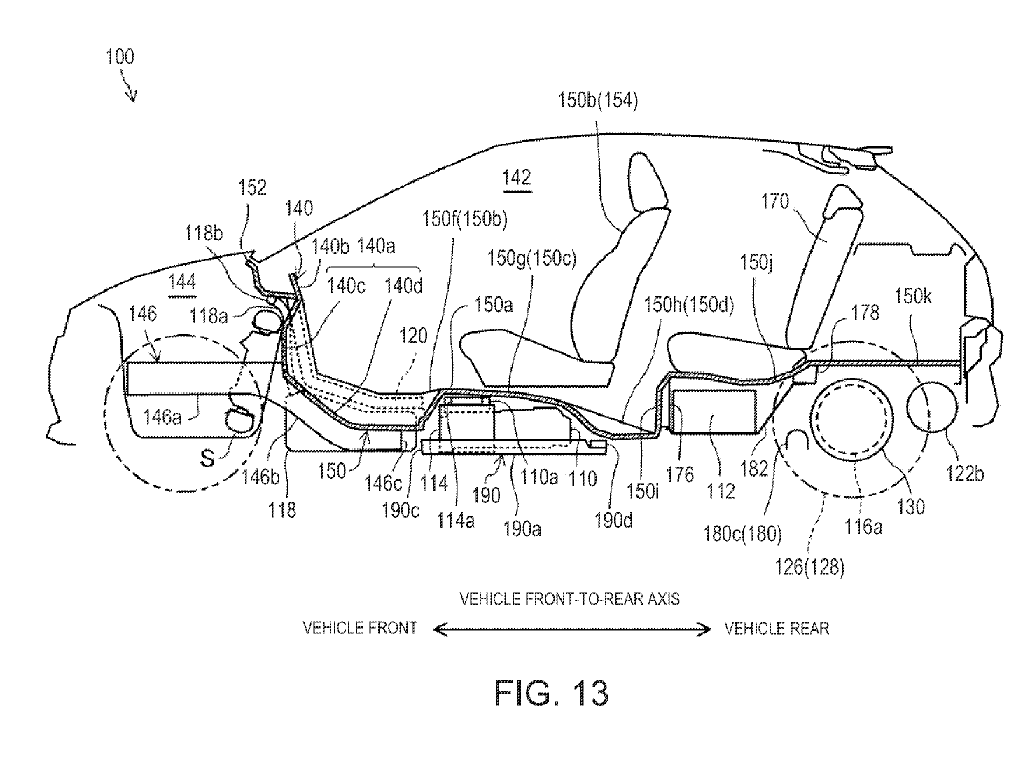

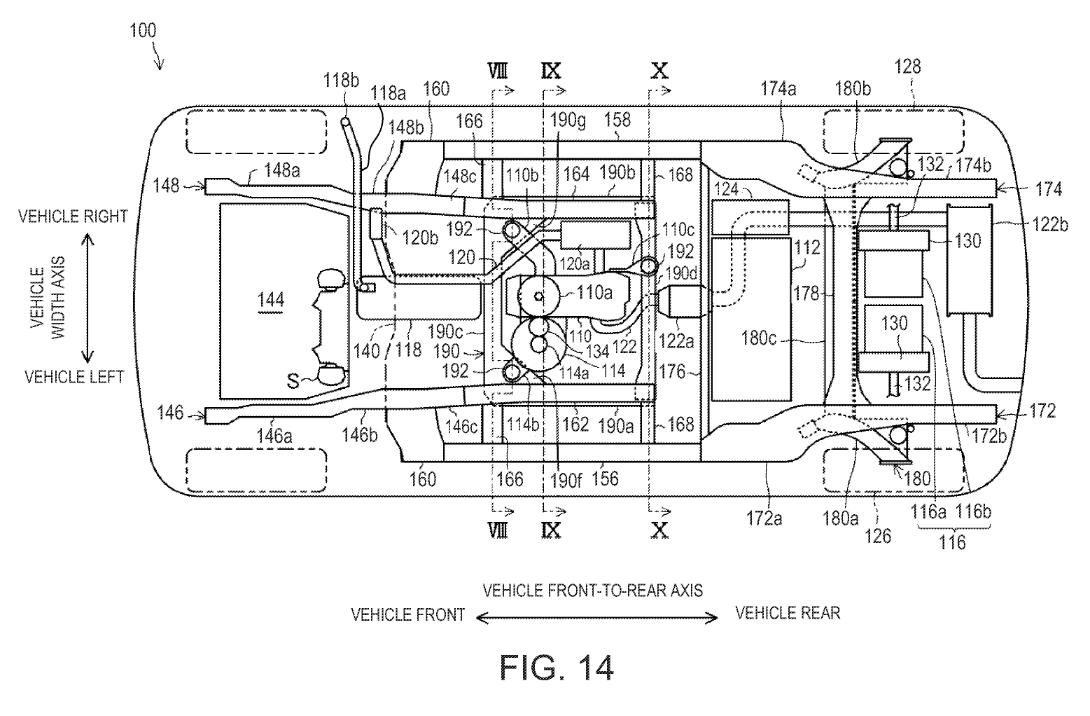

The engine 110 is a compact reciprocating engine having a single cylinder (hereinafter, may also be referred to as “the cylinder”). In this reciprocating engine, a fuel (e.g., gasoline) supplied from a fuel tank 118 for the engine is combusted in a combustion chamber to obtain energy, then a piston inside the cylinder is vertically moved by the energy, and the linear movement is converted into a rotary movement by a connecting rod and a crank shaft 110a (a driving shaft illustrated in FIG. 13 and other figures). The cylinder is communicated with an intake passage 120 (intake pipe) (illustrated in FIG. 13 and other figures) and an exhaust passage 122 (exhaust pipe) (illustrated in FIG. 14). In the intake passage 120, an air cleaner 120a using a filter for removing foreign matters and dusts in intake air is provided. In the exhaust passage 122, an exhaust emission control device 122a using a three-way catalyst for purifying hazardous components in exhaust gas, such as HC, CO and NOx, is provided, and a muffler 122b for cancelling out a pressure variation of the energy generated by the explosion sound of the exhaust gas and absorbing the energy to reduce the sound is provided downstream of the exhaust emission control device 122a. When a remaining battery level of the battery 112 is low (for example, when a state of charge SOC of the battery 112 becomes 30% or lower), the engine 110 is automatically operated. Note that, as described above, because the engine 110 is downsized, the fuel tank 118 and the air cleaner 120a are also downsized.

The battery 112 is a large-sized and large-capacity battery with high performance. The battery 112 is connected to the generator 114 and the motor 116 via an inverter 124, respectively, and is supplied and charged with the generated power from the generator 114 and regenerated power from the motor 116. Then, the battery 112 supplies the power to the motor 116 to drive the same. Further, when the vehicle 100 is not used, the battery 112 can be supplied and charged with the external power from the external power source.

The generator 114 is coupled to the crank shaft 110a of the engine 110 by its rotation shaft 114a (input shaft) (illustrated in FIG. 13 and other figures) and can be driven by the engine 110.

The motor 116 is constituted with a left rear wheel motor 116a (illustrated in FIG. 13 and other figures) and a right rear wheel motor 116b (illustrated in FIG. 14). The left rear wheel motor 116a is coupled to a left rear wheel 126 as the driving wheel via a final gear 130 and a driving shaft 132 (drive shaft) by its rotation shaft (output shaft), and, by being supplied with the power from the battery 112 and/or the generator 114, drives the left rear wheel 126. The right rear wheel motor 116b is coupled to a right rear wheel 128 as the driving wheel via the final gear 130 and the driving shaft 132 by its rotation shaft, and, by being supplied with the power from the battery 112 and/or the generator 114, it drives the right rear wheel 128. The final gear 130 ultimately reduces the rotational speed of the motors 116a and 116b and transmits the motive force of the motors 116a and 116b to the rear wheels 126 and 128, respectively.

The inverter 124 is integrally formed with an AC-DC converter 124a (an inverter for the generator 114) for converting AC power into DC power and a DC-AC converter 124b (an inverter for the motor 116) for converting DC power into AC power, and performs mutual transfers and conversions among the battery 112, the generator 114, and the motor 116. Specifically, when charging the battery 112 with the power from the generator 114, the AC power from the generator 114 is converted into the DC power by the AC-DC converter 124a to be supplied to the battery 112. Alternatively, when supplying the power from the battery 112 to the motor 116, the DC power from the battery 112 is converted into the AC power by the DC-AC converter 124b to be supplied to the motor 116. Moreover, when supplying the power from the generator 114 to the motor 116, the AC power from the generator 114 is converted into the DC power by the AC-DC converter 124a, and the DC power is then converted into the AC power by the DC-AC converter 124b to be supplied to the motor 116.

### Entire Structure of Electric Vehicle

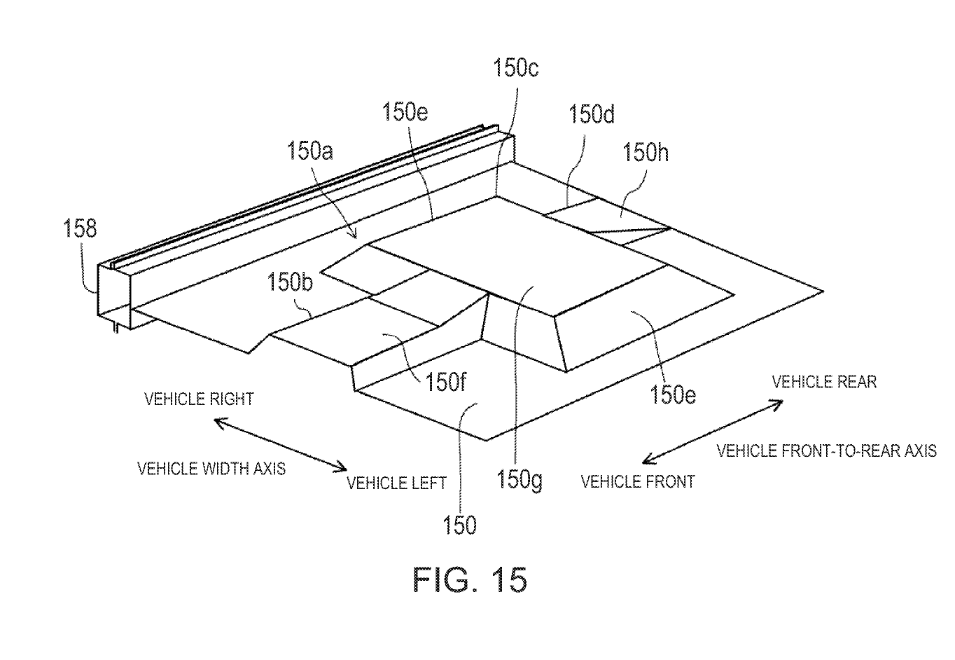

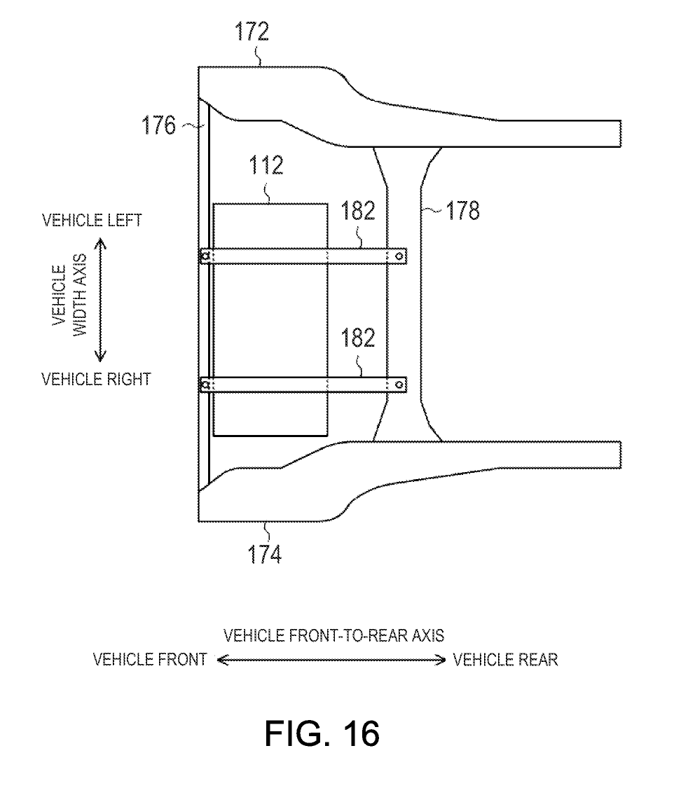

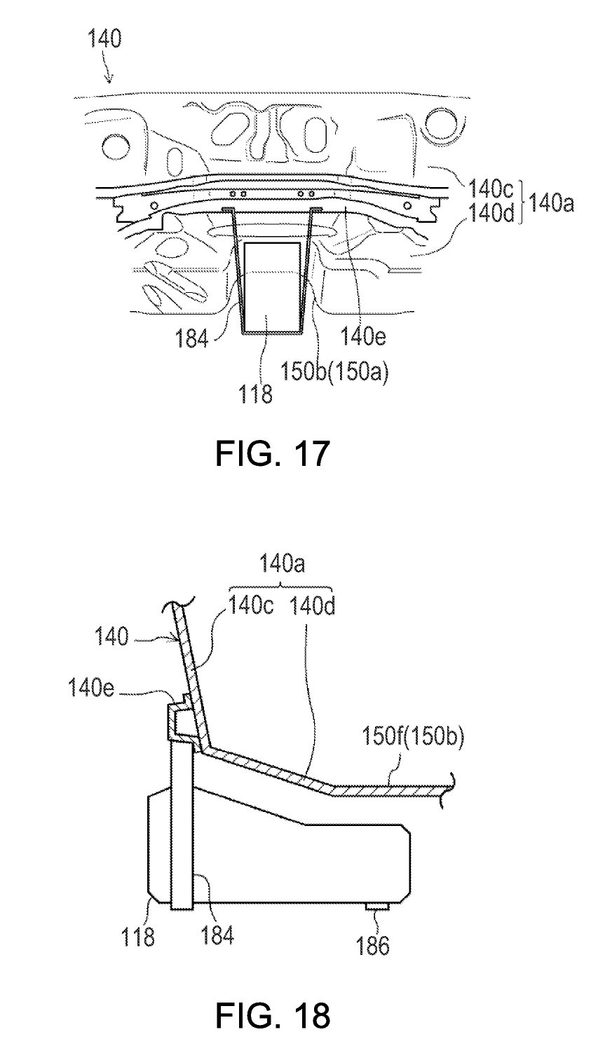

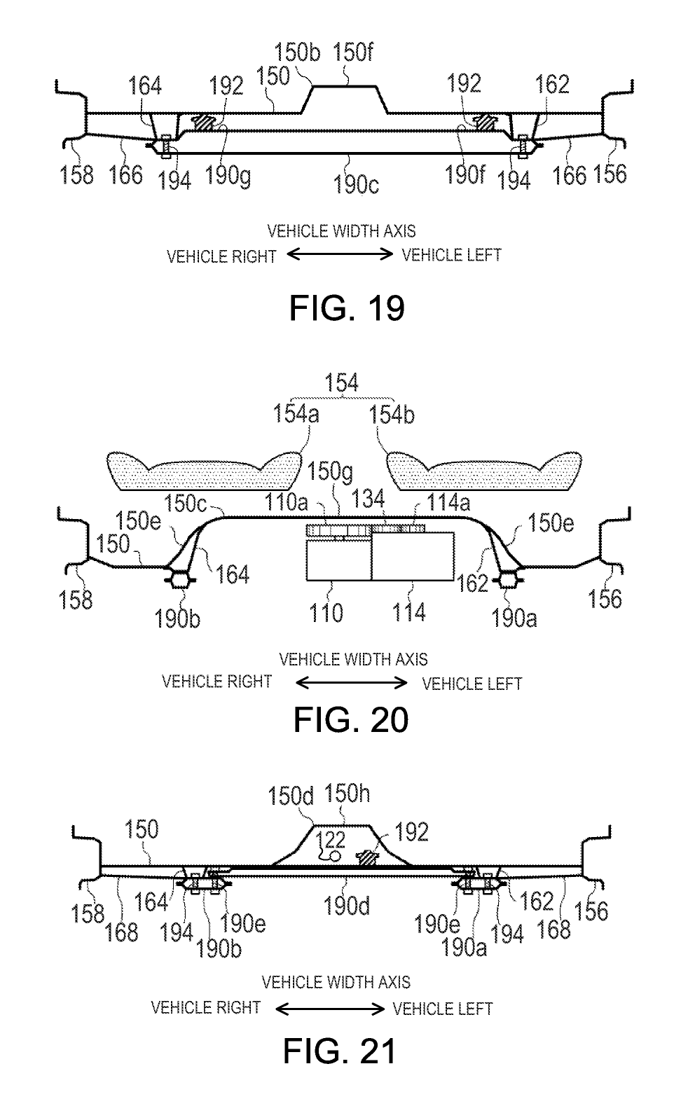

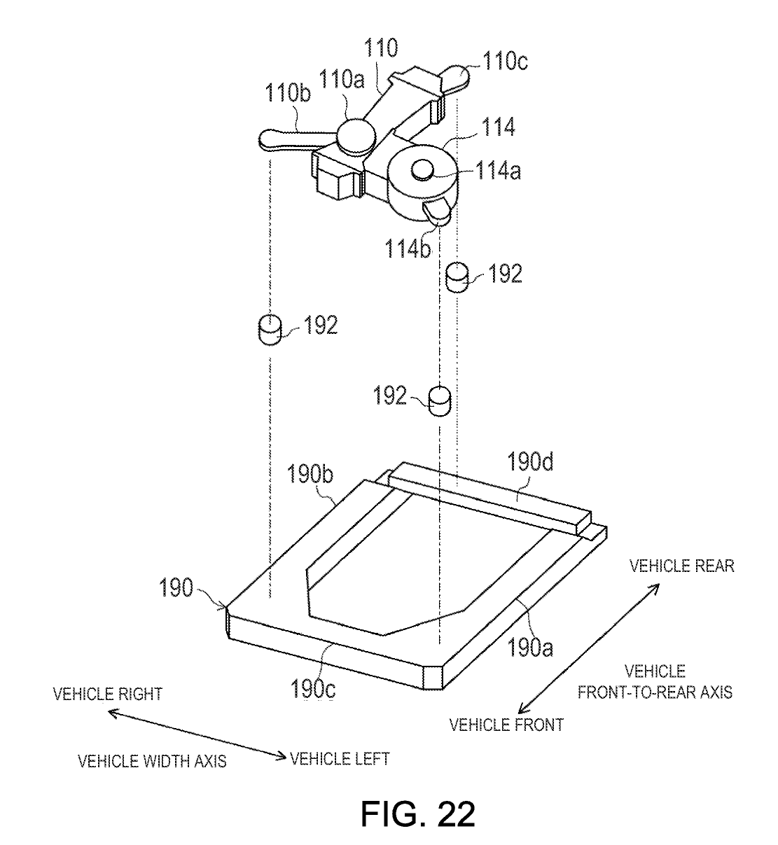

Hereinafter, the entire structure of the electric vehicle 100 is described. FIG. 13 is a side view schematically showing the entire structure of the electric vehicle. FIG. 14 is a plan view schematically showing the entire structure of the electric vehicle. FIG. 15 is a perspective view schematically showing a structure of a floor tunnel. FIG. 16 is a bottom view schematically showing a supporting structure of a battery to No. 3 and No. 4 cross members. FIG. 17 is a front view schematically showing a supporting structure of a fuel tank to a dashboard cross member. FIG. 18 is a side view schematically showing the supporting structure of the fuel tank to the dashboard cross member. FIG. 19 is a cross-sectional view taken along a line VIII-VIII of FIG. 14. FIG. 20 is across-sectional view taken along a line IX-IX of FIG. 14. FIG. 21 is across-sectional view taken along a line X-X of FIG. 14. FIG. 22 is an exploded perspective view schematically showing an attaching structure of an engine and a generator to a sub frame. Note that, in these figures, for easier view of the drawings, illustrations of the components are suitably omitted or simplified.

First, the structure of the vehicle body is described.

A vehicle front space in front of a dashboard panel 140 (a front space of the vehicle 100) which is partitioned from a vehicle cabin 142 by the dashboard panel 140 is formed in the front part of the vehicle 100 as a cargo space 144. A spare tire S is accommodated in a left rear part of the cargo space 144.

Left and right front side frames 146 and 148 are arranged on both sides of the cargo space 144 along the vehicle width axis and extend along the vehicle front-to-rear axis, respectively. These front side frames 146 and 148 include first horizontal parts 146a and 148a extending along the vehicle front-to-rear axis in front of the dashboard panel 140, inclined parts 146b and 148b extending obliquely downward and rearward from rear ends of the first horizontal parts 146a and 148a along a front surface of an inclined wall part 140d of a lower dashboard part 140a (described later), and second horizontal parts 146c and 148c extending rearward from rear ends of the inclined parts 146b and 148b along a lower surface of a floor panel 150 for forming a bottom surface of the cabin 142.

The dashboard panel 140 includes the lower dashboard part 140a standing upward from a front end of the floor panel 150 and extending along the vehicle width axis, and an upper dashboard part 140b extending upward from an upper end of the lower dashboard part 140a. The lower dashboard part 140a includes a vertical wall part 140c extending along the vertical axis of the vehicle and the inclined wall part 140d extending obliquely downward and rearward from a lower end of the vertical wall part 140c and coupled to the front end of the floor panel 150. A dashboard cross member 140e extending along the vehicle width axis to be coupled to respective rear end parts of the first horizontal parts 146a and 148a of the front side frames 146 and 148 is provided in a front surface of a lower end part of the vertical wall part 140c. A cowl panel 152 opening upward between a hood and a front wind shield is provided to the upper dashboard part 140b to extend along the vehicle width axis.

On the front part of the floor panel 150, a front seat 154 where a driver's seat 154a and a front passenger seat 154b are arranged along the vehicle width axis so as to be spaced therebetween. On both sides of the floor panel 150 along the vehicle width axis, left and right side sills 156 and 158 are arranged next to the cabin 142 (below the doors) to extend along the vehicle front-to-rear axis, respectively. These side sills 156 and 158 are coupled to respective connecting parts between the inclined part 146a and 148b with the second horizontal parts 146c and 148c of the front side frames 146 and 148 at the front ends thereof via respective coupling members 160 extending along the vehicle width axis.

On the lower surface of the floor panel 150, left and right B-frames 162 and 164 (corresponding to the “side frames” in the claims) are arranged inward from the respective side sills 156 and 158 along the vehicle width axis to extend along the vehicle front-to-rear axis. These B-frames 162 and 164 are for improving the rigidity of the floor panel 150. Front ends of the B-frames 162 and 164 are coupled to rear ends of the second horizontal parts 146c and 148c of the front side frames 146 and 148, and the front end parts of the B-frames 162 and 164 are coupled to respective front end parts of the side sills 156 and 158 via front coupling members 166 extending along the vehicle width axis. On the other hand, the rear end parts of B-frames 162 and 164 are coupled to the rear end parts of side sills 156 and 158 via rear coupling members 168 extending along the vehicle width axis. Further, the B-frames 162 and 164 extend inside a central tunnel part 150c of a floor tunnel 150a (described later) along inner surfaces of side wall parts 150e.

In the center part of floor panel 150 along the vehicle width axis, the floor tunnel 150a is formed in a substantially trapezoidal cross-sectional shape so as to bulge upwardly (a raise). The floor tunnel 150a is constituted with a front tunnel part 150b extending rearward in the cabin 142 and between the B-frames 162 and 164 from the lower dashboard part 140a, a central tunnel 150c (protruding part) extending rearward in the cabin 142 from a rear end of the front tunnel part 150b and having a length longer than the front tunnel 150b along the vehicle width axis, and a rear tunnel part 150d extending rearward in the cabin 142 and between the B-frames 162 and 164 from a rear end of the center part of the central tunnel part 150c along the vehicle width axis to reach a kick-up part 150i (described later) and having substantially the same length as the front tunnel part 150b along the vehicle width axis. A front part of front tunnel part 150b is formed so that an upper surface of an upper wall part 150f thereof extends substantially along the horizontal axis, while a rear part of the front tunnel part 150b is formed so that the upper surface of the upper wall part 150f is located higher as it goes rearward. The central tunnel part 150c is formed in a part of the floor panel 150 corresponding to the front seat 154, in which the vehicle width axis of the central tunnel part 150c extends from a position at the center part of the driver's seat 154a along the vehicle width axis to a position at the center part of the front passenger seat part 154b along the vehicle width axis, and the vehicle front-to-rear axis of the central tunnel part 150c extends from positions respectively corresponding to the front ends of the B-frames 162 and 164 to positions respectively corresponding to the rear ends of the B-frames 162 and 164. The central tunnel part 150c is formed so that an upper surface of an upper wall part 150g is located higher in the section forward from the section rearward. The rear tunnel part 150d is formed so that an upper surface of an upper wall part 150h is located lower as it goes rearward. Additionally, the front tunnel part 150b, the central tunnel part 150c, and the rear tunnel part 150d are formed so that the upper surfaces of the upper wall parts 150f to 150h becomes a continuous surface.

Rearward from the center part of the floor panel 150 along the vehicle front-to-rear axis, the kick up part 150i is formed to stand upward and a rear floor panel 150j is formed from the upper end of the kick up part 150i to extend rearward. A bench-type rear seat 170 is provided on a front part of the rear floor panel 150j. A cargo room floor 150k is formed rearward from the rear seat 170 on the rear floor panel 150j. That is, the cargo room floor 150k constitutes the rear part of the rear floor panel 150j.

Left and right rear side frames 172 and 174 are provided to the lower surface of both end parts of the rear floor panel 150j along the vehicle width axis and extend along the vehicle front-to-rear axis. These rear side frames 172 and 174 include inclined parts 172a and 174a inclined upward as they go rearward and horizontal parts 172b and 174b extending rearward from rear ends of the inclined parts 172a and 174a. The front ends of the inclined parts 172a and 174a are coupled to the rear ends of the side sills 156 and 158 respectively.

A No. 3 cross member 176 (first cross member) extending along the vehicle width axis below a front end part of the rear floor panel 150j and coupled to front end parts of the rear side frames 172 and 174 is provided on the back surface of the kick up part 150i. A No. 4 cross member 178 (second cross member) extending along the vehicle width axis, rearward from the No. 3 cross member 176, and coupled to center parts of the rear side frames 172 and 174 along the vehicle front-to-rear axis (respective connecting parts between the inclined parts 172a and 174a and the horizontal parts 172b and 174b of the rear side frames 172 and 174) is provided on the lower surface of the center part of the rear floor panel 150j along the vehicle front-to-rear axis. A lower surface of the No. 4 cross member 178 is located higher than a lower surface of the No. 3 cross member 176.

As for the rear wheels 126 and 128, a torsion-beam suspension 180 in which left and right trailing arms 180a and 180b are connected with each other by a beam referred to as a cross beam 180c is adopted in this embodiment. The cross beam 180c is arranged below the center part of the rear floor panel 150j along the vehicle front-to-rear axis (below the No. 4 cross member 178) and extends along the vehicle width axis, so as to be located forward from the wheel axle at the center of the rear wheels 126 and 128 and rearward from front ends of the rear wheels 126 and 128 in the vehicle side view. That is, the cross beam 180c constitutes a coupling member for coupling the left and right rear wheels 126 and 128 and constitutes a part of the suspension 180.

Next, the arrangement of the engine 110 and the generator 114 is described.

The engine 110 is arranged at substantially the same position along the vehicle front-to-rear axis as the front seat 154 along the vehicle front-to-rear axis (in this embodiment, a position below the floor panel 150 and between the driver's seat 154a and front passenger seat 154b) and below the center part of the floor panel 150 along the vehicle width axis so that the crank shaft 110a extends along the vertical axis. That is, the engine 110 is provided below the floor panel 150 and the center part of the vehicle 100 along the vehicle front-to-rear axis. Specifically, the engine 110 is arranged in the center part of the central tunnel 150c having a long width inside the floor tunnel 150a along the vehicle width axis so that the cylinder head side of the engine 110 is oriented rearward, the intake side is oriented rightward, and the crank shaft 110a is located in the front half of the high-floor section of the central tunnel part 150c.

The battery 112 is arranged below the front part of the rear floor panel 150j. That is, the battery 112 is provided below the rear seat 170. Further, the battery 112 is supported by the No. 3 cross member 176 provided near the front of the battery 112 and the No. 4 cross member 178 provided rear of the battery 112. More specifically, the battery 112 is supported from below by two band-shaped members 182 bridged between the lower surface of the No. 3 cross member 176 and the lower surface of the No. 4 cross member 178, so as to be spaced along the vehicle width axis.

The generator 114 is arranged closely to the engine 110 so that the rotation shaft 114a extends along the vertical axis and is arranged on the left of the front part of the engine 110 below the floor panel 150 to align with the crank shaft 110a of the engine 110 along the vehicle width axis. That is, the generator 114 is provided inside the central tunnel part 150c of the floor tunnel 150a so as to align with the engine 110 along the vehicle width axis. The rotation shaft 114a of the generator 114 is coupled to the crank shaft 110a of the engine 110 via a gear 134 in parallel. This gear 134 is arranged on the upper surface side of the engine 110 and the generator 114. Therefore the generator 114 is integrally coupled to the left front part of the engine 110, and thereby the engine 110 and the generator 114 constitute an assembly.

The left rear wheel motor 116a is integrally coupled to the final gear 130 and the rotation shaft thereof is arranged below and leftward of the front part of the cargo room floor 150k so as to extend along the vehicle width axis. The right rear wheel motor 116b is integrally coupled to the final gear 130 and is arranged so that the rotation shaft thereof extends along the vehicle width axis below and rightward of the front part of the cargo room floor 150k along the vehicle width axis. That is, the left rear wheel motor 116a and the right rear wheel motor 116b are arranged side by side along the vehicle width axis.

The fuel tank 118 is arranged forward from the engine 110 and the generator 114 so that a rear part thereof is located rearward from the dashboard panel 140, below the floor panel 150. That is, the rear part of fuel tank 118 is provided inside the front tunnel part 150b. Further, the fuel tank 118 is supported below the dashboard cross member 140e by the dashboard cross member 140e. Specifically, the front part of the fuel tank 18 is held and supported by a substantially U-shaped belt-shaped member 184 suspended from the center part of the dashboard cross member 140e along the vehicle width axis while the rear part of the fuel tank 118 is supported from below by a belt-shaped member 186 of a substantially flat plate shape bridge between front end parts of the B-frames 162 and 164. A fuel refilling pipe 118a of the fuel tank 118 extends rightward from the front end part of the fuel tank 118 and a fuel refilling port 118b thereof opens toward a right front fender.

The intake passage 120 starts from the engine 110, passes through the floor tunnel 150a, and reaches the cowl panel 152, and an intake port 120b thereof opens to the cowl panel 152 toward outside the vehicle. Specifically, the intake passage 120 extends rightward from the right rear part of the engine 110 and reaches a position on the left side of a right frame 190b of a sub frame 190 (described later), and then extends obliquely leftward to the front to reach a position between the engine 110 and the fuel tank 118. Then, further, the intake passage 120 passes between the fuel tank 118 and the upper wall part 150f of the front tunnel part 150b, extends forward, and reaches a position in front of the dashboard panel 140. Next, the intake passage 120 passes through the front side of the dashboard panel 140 (along the front surface of the dashboard panel 140), extends obliquely upward to the right, and reaches the cowl panel 152. The intake passage 120 takes into the engine 110 the outside air captured into the cowl panel 152. The air cleaner 120a is arranged on the right side of the rear part of the engine 110 below the floor panel 150.

The exhaust passage 122 extends rearward from the engine 110 below the floor panel 150. Specifically, the exhaust passage 122 passes through the central tunnel part 150c from the left rear part of the engine 110, curves rightward, and reaches a position at the center of the central tunnel part 150c along the vehicle width axis. The exhaust passage 122 further passes above a rear frame 190d of the sub frame 190 and inside the rear tunnel part 150d, extends rearward, and reaches a position above the battery 112. The exhaust passage 122 further reaches a position above the inverter 124. Next, the exhaust passage 122 extends rearward to reach a position rearward from the driving shaft 132 of the right rear wheel 128, extends leftward to reach a position rearward from the driving shaft 132 of the left rear wheel 126, and it further extends rearward. The exhaust emission control device 122a is arranged below the floor panel 150 at a position between the rear frame 190d of the sub frame 190 and the battery 112. The muffler 122b is arranged rearward from the right rear wheel motor 116b below and rearward of the cargo room floor 150k. The inverter 124 is arranged closely to the battery 112, rightward from the battery 112 located below and leftward of the front part of the rear floor panel 150j.

As described above, the generation module constituted with the engine 110, the generator 114, and the fuel tank 118 is arranged in the center part of the vehicle 100, and the electric driving module constituted with the battery 112, the motor 116, and the inverter 124 is arranged in the rear part of the vehicle 100, so that they are separately arranged. Thereby, harnesses and piping can be simplified and the weight distribution of the vehicle 100 can be properly adjusted.

The engine 110 and the generator 114 are attached to the sub frame 190 of the substantially rectangular frame shape in the plan view. Hereinafter, the attaching structure is described in detail.

The sub frame 190 includes left and right side frames 190a and 190b extending along the vehicle front-to-rear axis, a front frame 190c extending along the vehicle width axis and coupled to front end parts of the side frames 190a and 190b, and the rear frame 190d extending in parallel with the front frame 190c and coupled to respective rear end parts of the side frames 190a and 190b, rearward from the front frame 190c. The side frames 190a and 190b and the front frame 190c are integrally formed. Each upper surface of rear end parts of the side frames 190a and 190b is recessed downward, and the upper surfaces of the recessed parts are fixedly fastened to the rear frame 190d by a fastening member 190e. The side frames 190a and 190b have substantially the same length as the B-frames 162 and 164. The front and rear frames 190c and 190d are substantially the same length as the arrangement interval between the B-frames 162 and 164. Among four corner parts of the sub frame 190, two corner parts on the front side protrude inward from the sub frame 190 and each of the left and right protruded parts 190f and 190g is formed to be a substantially triangular shape.

The integrally-coupled engine 110 and generator 114 are elastically supported by the upper surface of the right protruded part 190g via a bracket 110b provided to the right front part of the engine 110 and a rubber mount 192, by the upper surface of the right part of the rear frame 190d via a bracket 110c provided to the right rear part of the engine 110 and a rubber mount 192, and by the upper surface of the left protruded part 190f via a bracket 114b provided to the left front side of the generator 114 and a rubber mount 192.

The sub frame 190 to which the engine 110 and the generator 114 are attached is attached to the lower surfaces of the B-frames 162 and 164. That is, after the engine 110 and the generator 114 are attached to the sub frame 190, the sub frame 190 to which the engine 110 and the generator 114 are attached is attached to the B-frames 162 and 164. Specifically, by a fastening member 194, the two corner parts on the front side among the four corner parts of the sub frame 190 are fixedly fastened to the respective lower surfaces of front end parts of the B-frames 162 and 164, and the other two corner parts on the rear side are attached to the respective lower surfaces of the rear end parts of the B-frames 162 and 164, so that the side frames 190a and 190b are allocated along the B-frames 162 and 164 respectively. Thus, by attaching to the B-frames 162 and 164 the sub frame 190 to which the engine 110 and the generator 114 are attached, the engine 110 and the generator 114 are arranged inside the central tunnel part 150c of the floor tunnel 150a, as described above. Additionally, the front and rear frames 190c and 190d function as members for receiving an impact load at the time of a side collision of the vehicle 100. That is, the front and rear frames 190c and 190d also function as cross members of the vehicle body.

As described above, the engine 110 and the generator 114 are attached to and supported by the vehicle body.

### Effects

Thereby, according to the above embodiment, the engine 110 is arranged below the floor panel 150 so as to be located at substantially the same position along the vehicle front-and-rear axis as the front seat 154 provided on the floor panel 150 along the vehicle front-to-rear axis (that is, below the floor panel 150 and the center part of the vehicle 100 along the vehicle front-to-rear axis), the engine 110 which is comparatively heavy is arranged in the center part of the vehicle 100 along the vehicle front-to-rear axis. Therefore, the center of gravity can be lowered and a yaw moment of inertia can be decreased.

Further, the engine 110 and the generator 114 are arranged below the floor panel 150, the engine 110 and the generator 114 are arranged in the space other than the front part space of the vehicle 100. Therefore, according to the above embodiment, the degree of freedom in designing the front part space of the vehicle 100 can be improved (for example, the front part space of the vehicle 100 may be used as a cargo space 144).

Thereby, the center of gravity can be lowered, the yaw moment of inertia can be decreased, and the degree of freedom in designing the front part space of the vehicle 100 can be improved.

Further, the engine 110 is arranged below the center part of the floor panel 150 along the vehicle width axis, the engine 110 which is comparatively heavy is arranged in the center part of the vehicle 100 along the vehicle width axis. Therefore the weight, the stability in traveling, and controlling of the vehicle can be improved.

Further, the engine 110 is arranged inside the central tunnel part 150c of the floor panel 150 which is formed in the part of the floor panel 150 corresponding to the front seat 154 so as to bulge upwardly. Therefore the space below the front seat 154 can effectively be used.

Further, the generator 114 is arranged on one side of the engine 110 along the vehicle width axis. Therefore, according to the above embodiment, the engine 110 and the generator 114 can be arranged closely to each other.

When applying a plug-in hybrid vehicle equipped with a downsized engine 110, the fuel tank 118 for the engine 110 can be downsized. Further, according to the above embodiment, when the fuel tank 18 is downsized, the fuel tank 118 can be arranged forward from the engine 110 and the generator 114 so that a part of the fuel tank 118 is located rearward from the dashboard panel 140 below the floor panel 150.

Further, the fuel tank 118 is supported below the dashboard cross member 140e provided forward from the dashboard panel 140 so as to extend along the vehicle width axis by the dashboard cross member 140e. Therefore the fuel tank 118 can be supported by the existing dashboard cross member 140e, thereby reducing the number of the components.

Moreover, the portion of the floor panel 150 corresponding to the front seat 154 (that is the central tunnel part 150c) is formed so that an upper surface of a front part of the portion is located higher than an upper surface of a rear part of the portion. Therefore, a leg space for a person sitting on a rear seat can be secured because of the rear part of the floor panel 150, of which the upper surface is relatively low, corresponding to the front seat 154.

Further, the sub frame 190 to which the engine 110 and the generator 114 are attached is attached to the left and right B-frames 162 and 164 provided below the floor panel 150 so as to extend along the vehicle front-to-rear axis. Therefore, at the time of an offset frontal collision, an impact load applied to one B-frame 162 (or 164) can be transmitted to the other B-frame 164 (or 162) via the sub frame 190, and the impact load applied at the time of the offset frontal collision can be dispersed.

Further, the fuel tank 118 is arranged in a part other than below the rear seat 170 where the fuel tank 118 is normally arranged. Therefore, the battery 112 can be arranged below the rear seat 170.

As described above, the battery 112 is supported by the No. 3 cross member 176 provided forward from the battery 112 and extending along the vehicle width axis, and the No. 4 cross member 178 provided rearward from the battery 112 and extending along the vehicle width axis. Therefore, the battery 112 can stably be supported by the No. 3 and No. 4 cross members 176 and 178 with comparatively high rigidity.

### Other Embodiments

In the above embodiments, the torsion-beam suspensions 80 and 180 are applied for the rear wheels 26, 28, 126 and 128. However, without limiting to this, a rigid axle suspension of a type in which drive shaft(s) attached with the rear wheels 26, 28, 126 and 128 at both ends is attached to the vehicle body via a spring may be applied. That is, the drive shaft constitutes the coupling member configuring a part of suspension for coupling the left and right rear wheels 26, 28, 126 and 128. The drive shaft is arranged near the wheel axles of the rear wheels 26 and 28, 126 and 128 in the vehicle side view. Further, in this case, the batteries 12 and 112 are arranged forward from the drive shaft and the motors 16 and 116 are arranged rearward from the drive shaft.

Further, in the above embodiments, each of the engines 10 and 110 is a reciprocating engine having a single cylinder. However, without limiting to this, each of them may be a reciprocating engine having two cylinders or a rotary engine having a single rotor. This rotary engine includes an eccentric shaft as its driving shaft.

Further, in the first embodiment, the crank shaft 10a of the engine 10 and the rotary shaft 14a of the generator 14 are coupled to each other via the belt 34. However, without limiting to this, a chain or a gear may be used for coupling.

In the second embodiment, the rear part of the fuel tank 118 is arranged at a position rearward from the dashboard panel 140, below the floor panel 150. However, at least a part of the fuel tank 18 is needed to be arranged at the position rearward from the dashboard panel 140, below the floor panel 150 (for example, the entire fuel tank 118 may be arranged at the position rearward from the dashboard panel 140, below the floor panel 150).

Further, in the above embodiments, the batteries 12 and 112 are arranged below the floor panel 50 and 150 of below the rear seats 70 and 170, respectively. However, without limiting to this, the batteries 12 and 112 may be arranged, for example, above the floor panel 50 and 150 and below the rear seats 70 and 170, respectively.

Further, in the second embodiment, the crank shaft 110a of the engine 110 and the rotary shaft 114a of the generator 114 are coupled to each other via the gear 134. However, without limiting to this, a chain or a belt may be used for coupling.

As described above, the present invention is not limited to the above embodiments, and it may be implemented in other various forms without deviating from the spirit or the subject matters.

Thus, the above described embodiments are merely illustrations in all aspects, and therefore, must not be interpreted in a limited way. The scope of the present invention is indicated by the range of the claims, but it is not chained to the descriptions in any way. In addition, all of modifications and changes falling under the equivalent range of the claims are within the scope of the present invention.

As described above, the structure of the electric vehicle according to the present invention can be applied to a use in need of lowering the center of gravity, decreasing the yaw moment of inertia, and improving the degree of freedom in designing the front part space of the vehicle.

1. A structure of an electric vehicle, comprising:
an engine;
an electric generator which is driven by the engine;
a battery which is supplied and charged with generated power at least from the electric generator; and
a motor which is supplied with power from the battery to drive driving wheels;
wherein the engine and the electric generator are arranged inside a floor tunnel that is formed in a center part of a floor panel along a vehicle width axis so as to extend along a vehicle front-to-rear axis and be bulged upward.

2. The structure of claim 1, wherein the electric generator is arranged forward from the engine; and
wherein an exhaust system of the engine extends rearward from the engine.

3. The structure of claim 1, further comprising a sub frame having a substantially rectangular frame shape in a plan view, the sub frame including:
left and right side frames extending along the vehicle front-to-rear axis;
a front frame extending along the vehicle width axis and coupled to front end parts of the side frames; and
a rear frame extending along the vehicle width axis, rearward from the front frame, and coupled to rear end parts of the side frames;
wherein the engine and the electric generator are attached to the sub frames; and
wherein the sub frames to which the engine and the electric generator are attached are attached to a body of the vehicle so that the side frames are arranged along respective side wall parts of the floor tunnel.

4. The structure of claim 1, wherein a cross member extending along the vehicle width axis is provided rearward from the engine;
wherein the battery is arranged rearward from the cross member; and
wherein the engine and the battery are supported by the cross member.

5. The structure of claim 1, wherein an intake system of the engine extends forward from the engine, passes through the floor tunnel, passes through a front of a dashboard panel, and reaches a cowl panel.

6. The structure of claim 1, further comprising a fuel tank for the engine, which is arranged forward from the engine and the electric generator, inside the floor tunnel.

7. The structure of claim 1, wherein the battery is arranged forward from a coupling member for coupling left and right rear wheels that serve as the driving wheels and constituting a part of a suspension, and arranged rearward from the engine; and
wherein the motor is arranged rearward from the coupling member.

8. A structure of an electric vehicle, comprising:
an engine;
an electric generator which is driven by the engine;
a battery which is supplied and charged with generated power at least from the electric generator; and
a motor which is supplied with power from the battery to drive driving wheels;
wherein the engine is arranged below a floor panel so that it is located at substantially a same position along a vehicle front-to-rear axis as a seat provided on the floor panel; and
wherein the electric generator is arranged below the floor panel.

9. The structure of claim 8, wherein the engine is arranged below a center part of the floor panel along a vehicle width axis.

10. The structure of claim 8, wherein the engine is arranged inside a bulged part of the floor panel that is formed so as to be bulged upward in a portion corresponding to the seat.

11. The structure of claim 8, wherein the electric generator is arranged on one side of the engine along a vehicle width axis.

12. The structure of claim 8, further comprising a fuel tank for the engine arranged forward from the engine and the electric generator so that at least a part of the fuel tank is located rearward from a dashboard panel, below the floor panel.

13. The structure of claim 12, wherein the fuel tank is supported by a dashboard cross member, below the dashboard cross member that is provided forward from the dashboard panel so as to extend along a vehicle width axis.

14. The structure of claim 8, wherein a portion of the floor panel corresponding to the seat is formed so that an upper surface of a front part of the portion is formed higher than an upper surface of a rear part of the portion;
wherein a driving shaft of the engine is arranged so as to be oriented along a vehicle vertical axis and located below the front portion of the floor panel corresponding to the seat; and
wherein a rotation shaft of the electric generator is arranged so as to be oriented along the vehicle vertical axis.

15. The structure of claim 8, wherein the engine and the electric generator are attached to a sub frame, the sub frame to which the engine and the electric generator are attached being attached to left and right side frames provided below the floor panel so as to extend along the vehicle front-to-rear axis.

16. The structure of claim 8, wherein the engine is arranged at substantially a same position along the vehicle front-to-rear axis as a front seat provided on the floor panel; and
wherein the battery is arranged below a rear seat provided on the floor panel, rearward from the front seat.

17. The structure of claim 16, wherein the battery is supported by a first cross member provided forward from the battery and extending along a vehicle width axis, and a second cross member provided rearward from the battery and extending along the vehicle width axis.

18. A structure of an electric vehicle, comprising:
an engine;
an electric generator which is driven by the engine;
a battery which is supplied and charged with generated power at least from the electric generator; and
a motor which is supplied with power from the battery to drive driving wheels;
wherein the engine is arranged below a floor panel, in a center part of the vehicle along a vehicle front-to-rear axis; and
wherein the electric generator is arranged below the floor panel.
